(19) United States
(12) Patent Application Publication
(10) Pub. No.: US 2021/0403686 A1
(43) Pub. Date: Dec. 30, 2021

(54) Molded Bale of Rubber Composition, Method for Producing Molded Bale, Crosslinking Rubber Composition, and Tread for Tire

(71) Applicant: Asahi Kasei Kabushiki Kaisha, Tokyo (JP)

(72) Inventors: Yoshifumi Araki, Tokyo (JP); Atsushi Yasumoto, Tokyo (JP); Tomohiro Kondo, Tokyo (JP); Akitomo Kikuchi, Tokyo (JP)

(73) Assignee: Asahi Kasei Kabushiki Kaisha, Tokyo (JP)

(21) Appl. No.: 17/356,894

(22) Filed: Jun. 24, 2021

(30) Foreign Application Priority Data
Jun. 26, 2020 (JP) 2020-110772
Apr. 28, 2021 (JP) 2021-075814

(51) Int. Cl. C08L 15/00; B60C 1/00; B60C 11/00

(52) U.S. Cl. CPC C08L 15/00; B60C 1/0016; B60C 2011/0025; C08L 2312/08; B60C 11/0008

(57) ABSTRACT

The present invention provides a molded bale of a rubber composition that is difficult to cold flow, and is difficult to be thermally deteriorated during production, and in which rigidity at 50° C. of a rubber composition for crosslinking obtained therefrom is difficult to be low, and change of tensile strength of the rubber composition for crosslinking after thermal history is small. The rubber composition contains: a rubber-like polymer (A) having an iodine value of 10 to 250, 3% by mass or more of an ethylene structure, and less than 10% by mass of a vinyl aromatic monomer block; aluminum (B); and nickel and/or cobalt (C), in which a content of the aluminum (B) is 2 ppm or more and 200 ppm or less, and a content of the nickel and/or cobalt (C) is 3 ppm or more and 100 ppm or less.

### BACKGROUND OF THE INVENTION

### Field of the Invention

The present invention relates to a molded bale of a rubber composition, a method for producing a molded bale, a rubber composition for crosslinking, and a tread for a tire.

### Description of the Related Art

In recent years, in the fields of rubber materials for tire treads, sheets, films and asphalt modification, a rubber composition containing a rubber-like polymer having an ethylene structure and containing a crosslinkable unsaturated group introduced therein has been proposed for purposes of increasing mechanical strength and permanent compression set (see, for example, International Publication Nos. WO2019/151126, WO2019/151127, and WO2019/078083).

The conventionally proposed rubber composition containing a rubber-like polymer having an ethylene structure and containing a crosslinkable unsaturated group introduced therein disadvantageously has, however, tendencies that cold flow of a molded article of the rubber composition easily occurs, that the shape is easily changed, that the rubber composition is thermally deteriorated during production, that a rubber composition for crosslinking obtained therefrom has low rigidity at 50° C., and that a rubber composition for crosslinking obtained therefrom is largely changed in tensile strength after thermal history.

Therefore, an object of the present invention is to provide a molded bale of a rubber composition that is difficult to cold flow, and is difficult to be thermally deteriorated during production, and in which rigidity at 50° C. of a rubber composition for crosslinking obtained therefrom is difficult to be low, and change of tensile strength of the rubber composition for crosslinking after thermal history is small.

### SUMMARY OF THE INVENTION

The present inventors made earnest studies to solve the above-described problems of the conventional techniques, resulting in finding the following: When an aluminum content, and a nickel and/or cobalt content in a rubber composition containing a rubber-like polymer having a specific structure are respectively specified to fall in prescribed ranges, a molded article of the rubber composition is difficult to cold flow, the rubber composition is difficult to be thermally deteriorated during production, rigidity at 50° C. of a rubber composition for crosslinking obtained therefrom is difficult to be low, and change of tensile strength of the rubber composition for crosslinking after thermal history is small. Thus, the present invention was accomplished.

Specifically, the present invention provides the following:

[1] A molded bale of a rubber composition comprising:

a rubber-like polymer (A) having an iodine value of 10 to 250, 3% by mass or more an ethylene structure, and less than 10% by mass of a vinyl aromatic monomer block;

aluminum (B); and

nickel and/or cobalt (C),

wherein a content of the aluminum (B) is 2 ppm or more and 200 ppm or less, and

a content of the nickel and/or cobalt (C) is 3 ppm or more and 100 ppm or less.

[2] The molded bale according to [1], wherein the rubber-like polymer (A) is a hydrogenated product of a conjugated diene-based polymer.

[3] The molded bale according to [1] or [2], wherein the rubber-like polymer (A) comprises 5% by mass or more of a vinyl aromatic monomer unit.

[4] The molded bale according to any one of [1] to [3], wherein the rubber-like polymer (A) comprises a nitrogen atom.

[5] The molded bale according to any one of [1] to [4], wherein the rubber-like polymer (A) has a modification ratio measured by column adsorption GPC of 40% by mass or more.

[6] The molded bale according to any one of [1] to [5], further comprising 30% by mass or less of a rubber softener (D).

[7] The molded bale according to any one of [1] to [6], comprising a water content of 0.05% by mass or more and 1.5% by mass or less.

[8] A method for producing the molded bale according to any one of [1] to [7], comprising:

a step of polymerizing the rubber-like polymer (A) in a solution;

a step of adding the aluminum (B) and the nickel and/or cobalt (C) to the solution containing the rubber-like polymer (A) to obtain a rubber composition; and

a step of molding the rubber composition containing the rubber-like polymer (A), the aluminum (B), and the nickel and/or cobalt (C).

[9] The method for producing the molded bale according to [8], comprising:

a step of removing a solvent by steam stripping from the solution containing the rubber-like polymer (A).

[10] The method for producing the molded bale according to [8] or [9], wherein the nickel and/or cobalt is allowed to remain in the rubber composition in such a manner that a content of the nickel and/or cobalt in the rubber composition is 10% by mass or more based on an amount of the nickel and/or cobalt added to the solution containing the rubber-like polymer (A).

[11] A rubber composition for crosslinking, comprising:

the rubber composition of the molded bale according to any one of [1] to [7]; and

a crosslinking agent,

wherein the crosslinking agent is contained in an amount of 0.1 parts by mass or more and 20 parts by mass or less with respect to 100 parts by mass of a rubber component.

[12] A tread for a tire, containing the rubber composition of the molded bale according to any one of [1] to [7].

According to the present invention, a molded bale of a rubber composition that is difficult to cold flow, and is difficult to be thermally deteriorated during production, and in which rigidity at 50° C. of a rubber composition for crosslinking obtained therefrom is difficult to be low, and change of tensile strength of the rubber composition for crosslinking after thermal history is small can be obtained.

### DETAILED DESCRIPTION OF THE PREFERRED EMBODIMENT

Now, an embodiment for practicing the present invention (hereinafter referred to as the “present embodiment”) will be described in detail.

It is noted that the following embodiment is merely illustrative for describing the present invention, and that the present invention is not limited to the following embodiment. The present invention can be practiced with modifications appropriately made within the scope thereof.

[Molded Bale of Rubber Composition]

A molded article of a rubber composition of the present embodiment is a molded bale of a rubber composition containing a rubber-like polymer (A) having an iodine value of 10 to 250, 3% by mass or more of an ethylene structure, and less than 10% by mass of a vinyl aromatic monomer block; aluminum (B); and nickel and/or cobalt (C), in which a content of the aluminum (B) is 2 ppm or more and 200 ppm or less, and a content of the nickel and/or cobalt (C) is 3 ppm or more and 100 ppm or less.

Owing to this configuration, a molded bale difficult to cold flow is obtained, and effects that thermal deterioration is difficult to occur during production, that rigidity at 50° C. of a rubber composition for crosslinking obtained therefrom is difficult to be low, and that change of tensile strength of the rubber composition for crosslinking after thermal history is small are obtained.

(Rubber-Like Polymer (A))

The rubber-like polymer (A) contained in the rubber composition contained in the molded bale of the present embodiment (hereinafter referred to as the rubber composition of the present embodiment) is a rubber-like polymer having an iodine value of 10 to 250, having 3% by mass or more of an ethylene structure, and less than 10% by mass of a vinyl aromatic monomer block.

The rubber-like polymer (A) contained in the molded bale of the rubber composition of the present embodiment is preferably a hydrogenated product of a random copolymer from the viewpoints of handleability of the molded bale, and a tensile property, heat resistance and weather resistance obtained in the form of a crosslinked product. Specifically, the molded bale obtained as a hydrogenated product of a random copolymer is excellent from the viewpoint of crushability of a bale as compared with a case where it is obtained as a block copolymer.

<Iodine Value>

The iodine value of the rubber-like polymer (A) contained in the rubber composition of the present embodiment is 10 to 250.

The iodine value is 10 or more, preferably 15 or more, more preferably 30 or more, further preferably 50 or more, and still further preferably 70 or more from the viewpoints of ease of crosslinking, adhesiveness of a packaging sheet of the molded bale of the rubber composition of the present embodiment, and fuel economy, mechanical strength and flexibility obtained in the form of a tire.

On the other hand, from the viewpoint of weather resistance of the rubber-like polymer (A), the iodine value is 250 or less, preferably 200 or less, more preferably 150 or less, further preferably 110 or less, and still further preferably 80 or less.

The iodine value can be measured in accordance with a method described in “JIS K 0070: 1992”.

The iodine value is a value, in terms of the weight in grams of iodine, corresponding to an amount of halogen reacting with 100 g of a target substance, and hence the iodine value is expressed in the unit of “g/100 g”.

Since a conjugated diene monomer unit has a double bond, for example, if a conjugated diene monomer and a vinyl aromatic monomer are copolymerized in a method for producing the rubber-like polymer (A) described below, the iodine value of the rubber-like polymer (A) is lower when the content of a conjugated monomer unit is lower. Alternatively, if a conjugated diene monomer unit is hydrogenated, the iodine value is lower as a hydrogenation rate is higher.

The iodine value of the rubber-like polymer (A) can be controlled to fall in the above-described numerical range by adjusting the amount of a conjugated diene monomer or the like having an unsaturated bond, polymerization conditions such as polymerization time and a polymerization temperature, and conditions employed in hydrogenation process such as a hydrogenation amount and hydrogenation time.

<Ethylene Structure Content>

The rubber-like polymer (A) contained in the rubber composition of the present embodiment has 3% by mass or more of an ethylene structure.

When the ethylene structure is 3% by mass or more, excellent mechanical strength is obtained. The ethylene structure is preferably 5% by mass or more, more preferably 30% by mass or more, and further preferably 40% by mass or more.

The ethylene structure is preferably 90% by mass or less, more preferably 80% by mass or less, and further preferably 70% by mass or less.

When the ethylene structure is 90% by mass or less, the rubber composition of the present embodiment tends to have sufficient rubber elasticity.

The ethylene structure in the rubber-like polymer (A) encompasses all ethylene structures such as an ethylene structure obtained by copolymerizing an ethylene monomer, and an ethylene structure obtained by polymerizing a conjugated diene monomer and then hydrogenating the resultant. For example, when a 1,4-butadiene unit is hydrogenated, two ethylene structures are obtained, and when a 1,4-isoprene unit is hydrogenated, one propylene structure and one ethylene structure are obtained.

The ethylene structure content of the rubber-like polymer (A) can be measured by a method described in Examples below, and can be controlled to fall in the above-described numerical range in accordance with an amount of ethylene added, an amount of a conjugated diene monomer added, a hydrogenation rate, and the like.

<Vinyl Aromatic Monomer Block Content>

The rubber-like polymer (A) has a vinyl aromatic monomer block content of less than 10% by mass (vinyl aromatic monomer block <10% by mass).

The vinyl aromatic monomer block refers to a block including a chain of eight or more aromatic vinyl monomer units.

When the vinyl aromatic monomer block content is less than 10% by mass, moldability of the rubber composition of the present embodiment into a molded bale and cuttability in measuring the molded bale tend to be excellent. Besides, when the rubber composition is used as a material of a tire, there is tendency that a tire excellent in fuel economy can be easily produced.

The aromatic vinyl monomer block content of the rubber-like polymer (A) is preferably 7% by mass or less, more preferably 5% by mass or less, and further preferably 3% by mass or less.

From the viewpoint of flexibility of the rubber-like polymer and the rubber composition, the number of vinyl aromatic monomer blocks each including a chain of 30 or more vinyl aromatic monomer units is preferably small or zero.

The vinyl aromatic monomer block content can be specifically measured, for example, when a polymer contained in the rubber-like polymer (A) is a butadiene-styrene copolymer, by decomposing the polymer by Kolthoff method (method described in I. M. KOLTHOFF, et al., J. Polym. Sci. 1, 429 (1946)) to analyze an amount of polystyrene insoluble in methanol. As another method, a known method, as described in International Publication No. WO2014/133097, such as measurement of a chain of styrene units by NMR can be employed for the measurement.

The vinyl aromatic monomer block content of the rubber-like polymer (A) can be controlled to fall in the above-described numerical range by a method for adding a vinyl aromatic monomer, or by adjusting addition of a polymerization aid, a polymerization temperature and the like.

<Monomer Unit for Causing Unsaturated Group to be Contained in Rubber-Like Polymer (A)>

The rubber-like polymer (A) preferably contains a monomer unit having an unsaturated group, such as a conjugated diene monomer unit or a myrcene, in a content of 2% by mass or more. From the viewpoints of economic efficiency and productivity, it is more preferable to contain a conjugated diene monomer unit.

A conjugated diene monomer unit or a myrcene contained as a component of the rubber-like polymer (A) has a double bond, and hence becomes a crosslinkable unsaturated group.

The content of the monomer unit having an unsaturated group, such as a conjugated diene monomer unit or a myrcene, in the rubber-like polymer (A) is closely related to the iodine value described above.

The content of the monomer unit having an unsaturated group, such as a conjugated diene monomer unit or a myrcene, is preferably 3% by mass or more, and more preferably 6% by mass or more. The content of a conjugated diene monomer unit is preferably 50% by mass or less, more preferably 30% by mass or less, and further preferably 20% by mass or less.

When the content of a conjugated diene monomer unit is 2% by mass or more, mechanical strength and abrasion resistance obtained in the form of a tire are excellent. When the content is 50% by mass or less, weather resistance and tensile energy of the rubber composition are excellent.

The content of the monomer unit having an unsaturated group, such as a conjugated diene monomer unit or a myrcene, in the rubber-like polymer (A) can be measured by a method described in the Examples below, and can be controlled to fall in the above-described numerical range by adjusting an amount of the monomer having an unsaturated group such as a conjugated diene monomer unit or a myrcene described below, and a hydrogenation rate of the conjugated diene monomer.

(Aluminum (B))

The rubber composition of the present embodiment contains aluminum (B), and the content of the aluminum (B) in the rubber composition of the present embodiment is 2 ppm or more and 200 ppm or less.

The content of the aluminum (B) in the rubber composition of the present embodiment is 2 ppm or more from the viewpoint of a cold flow property of a molded article of the rubber composition. The content is preferably 4 ppm or more, more preferably 6 ppm or more, and further preferably 10 ppm or more.

On the other hand, from the viewpoint of resistance to thermal deterioration of the rubber composition of the present embodiment, the content is 200 ppm or less, preferably 80 ppm or less, more preferably 40 ppm or less, and further preferably 25 ppm or less.

Cold flow can be inhibited by the presence of the aluminum (B) probably for the following reason: A compound containing aluminum is dispersed in a micronized form, and during micronization process, is entangled with molecules of the rubber-like polymer (A). The thus formed entangled portions work as physical crosslinking points in the rubber composition, so as to inhibit cold flow.

The content of the aluminum in the rubber composition can be measured by a method described in the Examples below, and can be controlled to fall in the above-described numerical range by adjusting the type and an amount of a polymerization catalyst or a hydrogenation catalyst added, and conditions of decalcification process or process for removing a solvent described below.

The aluminum (B) contained in the rubber composition of the present embodiment is preferably a residue of a hydrogenation catalyst used in producing the rubber-like polymer (A).

Preferable examples of the hydrogenation catalyst used in producing the rubber-like polymer (A) include, from the viewpoint that a metal content in the rubber composition of the present embodiment can be easily adjusted to a prescribed amount, those prepared by mixing a Ni compound and an aluminum compound and those prepared by mixing a Co compound and an aluminum compound as described in International Publication Nos. WO2002/2663, WO2014/046016, WO2014/046017, WO2014/065283, WO2015/6179, WO2017/090714, WO2017/090714, WO2017/199983, and WO2019/103047.

Preferable examples of the aluminum compound include, but are not limited to, trimethylaluminum, triethylaluminum, triisobutylaluminum, tripentylaluminum, trihexylaluminum, triphenylaluminum, diethylaluminum chloride, dimethylaluminum chloride, ethylaluminum dichloride, methylaluminum sesquichloride, ethylaluminum sesquichloride, diethylaluminum hydride, diisobutylaluminum hydride, triphenylaluminum, tri(2-ethylhexyl)aluminum, (2-ethylhexyl)aluminum dichloride, methylaluminoxane, hydrogenated diisobutylaluminum, and ethylaluminoxane.

(Nickel and/or Cobalt (C))

The content of the nickel and/or cobalt (C) in the rubber composition of the present embodiment is 3 ppm or more and 100 ppm or less (3 ppm≤content of nickel and/or cobalt (C)≤100 ppm).

From the viewpoint of increasing rigidity at 50° C. obtained when the rubber composition of the present embodiment is formed as a rubber composition for crosslinking, the content is 3 ppm or more, preferably 10 ppm or more, and more preferably 15 ppm or more. On the other hand, from the viewpoint of reducing change of tensile strength after thermal history obtained when the rubber composition of the present embodiment is formed as a rubber composition for crosslinking, the content is 100 ppm or less, preferably 50 ppm or less, and more preferably 30 ppm or less.

The content of the nickel and/or cobalt (C) refers to a total amount of nickel and cobalt when nickel and cobalt are contained, and to a content of either nickel or cobalt when either is contained.

The rubber composition for crosslinking obtains high rigidity at 50° C. owing to the presence of the nickel and/or cobalt (C) is probably because nickel or cobalt accelerates a crosslinking reaction to increase the rigidity.

The content of the nickel and/or cobalt (C) in the rubber-like polymer (A) can be measured by a method described in the Examples below, and can be controlled to fall in the above-described numerical range by adjusting the type and the amount of a hydrogenation catalyst added, and conditions of the decalcification process or process for removing a solvent described below.

The nickel and/or cobalt (C) contained in the rubber composition of the present embodiment is preferably a residue of a hydrogenation catalyst used in producing the rubber-like polymer (A), and the content of the nickel and/or cobalt (C) corresponds to an amount of the residue of the hydrogenation catalyst.

As the hydrogenation catalyst, from the viewpoints of a hydrogenation speed and economic efficiency, nickel octylate is preferred as a Ni compound, and Co octylate is preferred as a Co compound. A mixture or a reaction product of nickel octylate and an aluminum compound is more preferred.

The contents of the aluminum (B) and the nickel and/or cobalt (C) in the rubber composition of the present embodiment are defined as amounts of the respective elements even if these are contained in the form of compounds.

As described above, the aluminum (B) and the nickel and/or cobalt (C) corresponding to the residues of a hydrogenation catalyst component are finely dispersed in the rubber composition, or changed to a compound or a complex difficult to be specified, and there is a possibility that physical properties of the rubber composition may be largely affected. Therefore, in the rubber composition of the present embodiment, the numerical ranges of the content of the aluminum (B) and the content of the nickel and/or cobalt (C) are specified as described above to improve properties of the rubber composition.

From the viewpoint of reaction efficiency of the hydrogenation reaction performed in production process of the rubber-like polymer (A), it is preferable to add a prescribed amount of nickel and/or cobalt, but after adding a hydrogenation catalyst in an amount preferable from the viewpoint of the hydrogenation reaction efficiency, in order to inhibit cold flow caused by a metal remaining in the resultant rubber composition, or to assure a practically sufficiently good level of contamination resistance of a mold, it is necessary to suppress the amount of the residue of the hydrogenation catalyst. From the viewpoint of balance between the reaction efficiency and the suppression of the amount of the residue of the catalyst, a ratio of nickel and/or cobalt remaining in the rubber composition to nickel and/or cobalt added to a solution containing the rubber-like polymer (A) is preferably 10% by mass or more, more preferably 12% by mass or more, and further preferably 15% by mass or more.

Removal efficiency of the hydrogenation catalyst is lowered as the remaining amount of the hydrogenation catalyst is smaller. Therefore, from the viewpoint of appropriately keeping the content of the nickel and/or cobalt (C) in the rubber composition with the hydrogenation catalyst removed to some extent, it is preferable to control the hydrogenation catalyst to remain by 10% by mass or more also from the viewpoint that good removal efficiency of the hydrogenation catalyst is kept without excessively increasing burden required for removing the hydrogenation catalyst.

(Another Metal)

An example of another metal to be contained in the rubber composition of the present embodiment includes lithium.

A content of the lithium is preferably 60 ppm or less, more preferably 50 ppm or less, further preferably 40 ppm or less, and still further preferably 30 ppm or less from the viewpoint of discoloration resistance of the rubber composition. On the other hand, from the viewpoint of tensile elongation obtained by crosslinking, the content is preferably 2 ppm or more, more preferably 5 ppm or more, and further preferably 10 ppm or more.

(Particle Size of Metal or Metal Compound in Rubber Composition)

With respect to a particle size of a metal or a metal compound contained in the rubber composition of the present embodiment, from the viewpoints of peeling resistance of the rubber composition from the molded bale and balance of smoothness obtained when the composition is formed into a sheet, the particle size of 60% by volume or more of a total amount, 100% by volume, of particles of the metal or metal compound is preferably 0.1 to 80 μm, and it is more preferable that the particle size of 80% by volume or more fall in this numerical range.

The particle size can be measured by analyzing, with a laser diffraction type particle size distribution analyzer, a polymer solution obtained by dissolving the rubber composition containing the metal or metal compound in an inert solvent.

(Suitable Structure of Rubber-Like Polymer (A))

<Hydrogenated Polymer>

The rubber-like polymer (A) is preferably a hydrogenated polymer obtained by hydrogenating some or most of double bonds of conjugated diene monomer units contained in a conjugated diene-based polymer obtained by polymerizing or copolymerizing at least a conjugated diene monomer.

An unsaturated group contained in the rubber-like polymer (A) contains a conjugated diene monomer unit. In other words, in the production process of the rubber-like polymer (A), in hydrogenating some or most of double bonds contained in a polymer after polymerizing or copolymerizing at least a conjugated diene monomer, it is preferable to contain a conjugated diene monomer unit left not hydrogenated for obtaining a desired iodine value among conjugated diene monomer units.

As a method for performing polymerization or copolymerization of at least a conjugated diene monomer and then hydrogenating the resultant, as described in International Publication No. WO96/005250, Japanese Patent Laid-Open No. 2000-053706, and International Publication Nos. WO2003/085010, WO2019/151126, WO2019/151127, WO2002/002663, WO2015/006179, WO2019/103047, and WO2019/199983, a method in which a conjugated diene monomer is polymerized by anionic polymerization, or copolymerized with an additional monomer if necessary, with various additives under various conditions, and then hydrogenating the resultant is preferably employed.

<Monomer Contained in Rubber-Like Polymer (A)>

The rubber-like polymer (A) can be formed from a conjugated diene monomer, and an additional monomer if necessary.

Examples of the conjugated diene monomer include, but are not limited to, 1,3-butadiene, isoprene, 2,3-dimethyl-1,3-butadiene, 1,3-pentadiene, 3-methyl-1,3-pentadiene, 1,3-hexadiene, and 1,3-heptadiene.

Among these, from the viewpoint of industrial availability, 1,3-butadiene and isoprene are preferred, and 1,3-butadiene is more preferred. One of these may be singly used, or two or more of these may be used together.

The additional monomer used if necessary is not especially limited, and from the viewpoint of mechanical strength obtained in the form of a tire, a vinyl aromatic monomer is preferably used. Examples of the vinyl aromatic monomer include, but are not limited to, styrene, p-methylstyrene, α-methylstyrene, vinyl ethyl benzene, vinyl xylene, vinyl naphthalene, diphenylethylene, vinyl benzyl dimethylamine, (4-vinylbenzyl)dimethyl aminoethyl ether, N,N-dimethylaminoethyl styrene, N,N-dimethylaminomethyl styrene, and tertiary amino group-containing diphenylethylene (such as 1-(4-N,N-dimethylaminophenyl)-1-phenylethylene). Among these, from the viewpoint of industrial availability, styrene is preferred. One of these may be singly used, or two or more of these may be used together.

As the additional monomer used if necessary, monomers such as unsaturated carboxylic acid ester, unsaturated carboxylic acid, an α,β-unsaturated nitrile compound, α-olefin (such as propylene, butylene, pentene, or hexene), ethylene, myrcene, ethylidene norbornene, isopropylidene norbornene, cyclopentadiene, and divinylbenzene can be used.

<Vinyl Bond Content in Rubber-like Polymer (A)>

A vinyl bond content in a conjugated diene monomer unit of a conjugated diene-based polymer before hydrogenation in the rubber-like polymer (A) is, from the viewpoints of productivity of the rubber-like polymer (A) and high wet skid resistance obtained in the form of a tire, preferably 10% by mol or more, and more preferably 20% by mol or more. From the viewpoint of resistance to thermal deterioration and weather resistance obtained when the composition is used in a tire, the vinyl bond content is preferably 75% by mol or less, more preferably 60% by mol or less, further preferably 45% by mol or less, and still further preferably 30% by mol or less.

The vinyl bond content can be measured by a method described in the Examples below.

The vinyl bond content can be controlled to fall in the above-described numerical range by adjusting a polymerization temperature and an amount of a polar compound added in polymerization.

<Polymerization and Hydrogenation Process of Rubber-like Polymer (A)>

The polymerization process and the hydrogenation process for producing the rubber-like polymer (A) can be performed respectively by either a batch method or a continuous method.

Intermolecular and intramolecular distributions in the rubber-like polymer (A) of the hydrogenation rate, the ethylene, and the monomer units such as the conjugated diene monomer and the vinyl aromatic monomer are not especially limited but these may be uniformly present, non-uniformly present, or present with a distribution.

<Content of Vinyl Aromatic Monomer Unit>

A content of the vinyl aromatic monomer unit in the rubber-like polymer (A) is preferably 5% by mass or more, more preferably 10% by mass or more, further preferably 15% by mass or more, and still further preferably 20% by mass or more from the viewpoints of resistance to deformation of a molded article during transport, and break strength and wet skid resistance obtained when the composition is used in a tire tread.

On the other hand, from the viewpoints of cuttability in measuring the molded bale, making a rubber component difficult to aggregate in solvent removal process, making a metal content in the rubber composition easily adjusted to a desired amount, and fuel economy and abrasion resistance obtained when the composition is used in a tire tread, the content is preferably 45% by mass or less, more preferably 30% by mass or less, and further preferably 25% by mass or less.

Besides, if a high modulus is required as in a run flat tire member or the like, the content is preferably 30% by mass or more.

The content of the vinyl aromatic monomer unit in the rubber-like polymer (A) can be measured by a method described in the Examples below, and can be controlled to fall in the above-described numerical range by adjusting the amount of the vinyl aromatic monomer added in the polymerization process.

<Nitrogen Atom>

The rubber-like polymer (A) preferably contains a nitrogen atom from the viewpoints of peeling resistance of the rubber composition from the molded bale of the rubber composition of the present embodiment and fuel economy obtained in the form of a tire.

A nitrogen atom can be contained in the rubber-like polymer (A) by using, in the production process of the rubber-like polymer (A), for example, a coupling agent containing a nitrogen atom.

<Modification Ratio>

The rubber-like polymer (A) has a modification ratio, measured by column adsorption GPC of the rubber-like polymer (A), of preferably 40% by mass or more, more preferably 60% by mass or more, and further preferably 70% by mass or more from the viewpoint of dispersibility of silica obtained in producing a tire using silica.

Herein, the term “modification ratio” refers to a mass ratio of a polymer having a nitrogen atom-containing functional group to the total amount of the rubber-like polymer (A).

A position where a nitrogen atom is introduced in the rubber-like polymer (A) may be any one of a polymerization starting end, a molecular chain (including a graft product), and a polymerization end of the rubber-like polymer (A).

In the rubber-like polymer (A), from the viewpoints of polymerization productivity, a high modification ratio, and abrasion resistance and fuel economy obtained in the form of a tire, it is preferable that a tin atom or a nitrogen atom be introduced into the rubber-like polymer (A) by a coupling reaction performed with a coupling agent containing a tin atom or a nitrogen atom. It is more preferable that a nitrogen atom be introduced into the rubber-like polymer (A) with a coupling agent containing a nitrogen atom.

As a coupling agent containing a nitrogen atom, from the viewpoints of polymerization productivity and a high modification ratio, an isocyanate compound, an isothiocyanate compound, an isocyanuric acid derivative, a nitrogen group-containing carbonyl compound, a nitrogen group-containing vinyl compound, a nitrogen group-containing epoxy compound, a nitrogen group-containing alkoxysilane compound and the like are preferred.

Among these coupling agents containing a nitrogen atom, from the viewpoints of polymerization productivity of the rubber-like polymer (A), a high modification ratio, and tensile strength obtained in the form of a tire, a nitrogen group-containing alkoxysilane compound is more preferred.

Examples of the nitrogen group-containing alkoxysilane compound include, but are not limited to, 2,2-dimethoxy-1-(3-trimethoxysilylpropyl)-1-aza-2-silacyclopentane, 2,2-diethoxy-1-(3-triethoxysilylpropyl)-1-aza-2-silacyclopentane, 2,2-dimethoxy-1-(4-trimethoxysilylbutyl)-1-aza-2-silacyclohexane, 2,2-dimethoxy-1-(5-trimethoxysilylpentyl)-1-aza-2-silacycloheptane, 2,2-dimethoxy-1-(3-dimethoxymethylsilylpropyl)-1-aza-2-silacyclopentane, 2,2-diethoxy-1-(3-diethoxyethylsilylpropyl)-1-aza-2-silacyclopentane, 2-methoxy-2-methyl-1-(3-trimethoxysilylpropyl)-1-aza-2-silacyclopentane, 2-ethoxy-2-ethyl-1-(3-triethoxysilylpropyl)-1-aza-2-silacyclopentane, 2-methoxy-2-methyl-1-(3-dimethoxymethylsilylpropyl)-1-aza-2-silacyclopentane, 2-ethoxy-2-ethyl-1-(3-diethoxyethylsilylpropyl)-1-aza-2-silacyclopentane, tris(3-trimethoxysilylpropyl)amine, tris(3-methyldimethoxysilylpropyl)amine, tris(3-triethoxysilylpropyl)amine, tris(3-methyldiethoxysilylpropyl)amine, tris(trimethoxysilylmethyl)amine, tris(2-trimethoxysilylethyl)amine, tris(4-trimethoxysilylbutyl)amine, tetrakis[3-(2,2-dimethoxy-1-aza-2-silacyclopentane)propyl]-1,3-propanediamine, tetrakis(3-trimethoxysilylpropyl)-1,3-propanediamine, tetrakis(3-trimethoxysilylpropyl)-1,3-bisaminomethylcyclohexane, and N¹-(3-(bis(3-(trimethoxysilyl)propyl)amino)propyl)-N¹-methyl-N³-(3-(methyl(3-(trimethoxysilyl)propyl)amino)propyl)-N³-(3-(trimethoxysilyl)propyl)-1,3-propanediamine.

(Physical Properties of Rubber-Like Polymer (A) and Rubber Composition)

<Glass Transition Temperature>

A glass transition temperature of the rubber-like polymer (A) is preferably −90° C. or more, more preferably −80° C. or more, and further preferably −75° C. or more from the viewpoint of tensile strength obtained in the form of a tire.

On the other hand, from the viewpoints of cut resistance of a sheet obtained in producing a tire and flexibility obtained in the form of a tire, the glass transition temperature is preferably −15° C. or less, more preferably −30° C. or less, and further preferably −40° C. or less.

With respect to the glass transition temperature, a peak top (an inflection point) of a DSC differential curve obtained by recording a DSC curve during temperature increase in a prescribed temperature range in accordance with ISO 22768: 2006 is defined as the glass transition temperature.

<Weight Average Molecular Weight>

A weight average molecular weight of the rubber-like polymer (A) is preferably 150,000 or more from the viewpoints of shape stability of a molded article obtained using the rubber composition of the present embodiment, and crack resistance of a crosslinked product obtained using the rubber composition. The weight average molecular weight is more preferably 200,000 or more, further preferably 310,000 or more, and still further preferably 350,000 or more.

On the other hand, from the viewpoint of processability obtained in forming the rubber composition of the present embodiment as a rubber composition for crosslinking, the weight average molecular weight is preferably 1,000,000 or less, more preferably 500,000 or less, and further preferably 400,000 or less.

From the viewpoint of fuel economy obtained when the rubber composition is used in a tire, a molecular weight distribution (=weight average molecular weight/number average molecular weight) of the rubber-like polymer (A) is preferably 2.0 or less, more preferably 1.8 or less, and further preferably 1.6 or less. On the other hand, from the viewpoint of processability obtained when the rubber composition is formed as a crosslinking composition, the molecular weight distribution is preferably 1.05 or more, more preferably 1.2 or more, and further preferably 1.4 or more.

The weight average molecular weight and the molecular weight distribution can be calculated based on a molecular weight in terms of polystyrene measured by GPC (gel permeation chromatography), and can be measured by a method described in the Examples below.

<Mooney Viscosity>

Mooney viscosities of the rubber-like polymer (A) and the rubber composition of the present embodiment can be indexes including information of the rubber-like polymer (A), such as the molecular weight, the molecular weight distribution, a branch number, and a content of a softener.

The Mooney viscosity measured at 100° C. of the rubber composition of the present embodiment is preferably 40 or more, more preferably 50 or more, and further preferably 55 or more from the viewpoints of abrasion resistance, steering stability and break strength obtained when the rubber composition for crosslinking is used in a tire.

On the other hand, from the viewpoints of productivity of the rubber-like polymer (A) and the rubber composition of the present embodiment, and processaibility obtained in producing a composition with a filler and the like blended, the Mooney viscosity is preferably 170 or less, more preferably 150 or less, further preferably 130 or less, and still further preferably 110 or less.

As a measurement method for the Mooney viscosity, a method prescribed in ISO 289 can be applied.

(Rubber Softener (D))

The rubber composition of the present embodiment may contain a rubber softener (D) if necessary. A content of the rubber softener (D) is preferably 30% by mass or less.

For improving productivity of the rubber-like polymer (A) and processability obtained in blending an inorganic filler and the like in producing a tire, the content of the rubber softener (D) in the rubber composition of the present embodiment is preferably 1 to 30% by mass.

If the rubber-like polymer (A) has a high molecular weight, for example, if the weight average molecular weight exceeds 1,000,000, the content of the rubber softener (D) is preferably 15 to 30% by mass. On the other hand, if the rubber composition contains a filler blended therein, the content of the rubber softener (D) is preferably 1 to 15% by mass from the viewpoint of increasing the degree of blending freedom.

The content of the rubber softener (D) in the rubber composition of the present embodiment is more preferably 20% by mass or less, further preferably 10% by mass or less, and still further preferably 5% by mass or less from the viewpoint of inhibiting degradation over time caused in the form of a tire.

The rubber softener (D) is not especially limited, and examples include an extender oil, a liquid rubber, and a resin.

From the viewpoints of processability, productivity, and economic efficiency, the rubber softener (D) is preferably an extender oil.

As a method for adding the rubber softener (D) to the rubber composition of the present embodiment, although not limited to the following, a method in which the rubber softener (D) is added to be mixed with a polymer solution, and the thus obtained polymer solution containing the rubber softener is desolvated is preferably employed.

Examples of the extender oil include, but are not limited to, an aromatic oil, a naphthenic oil, and a paraffin oil.

Among these, from the viewpoint of environmental safety, and from the viewpoints of oil bleed prevention and wet grip characteristics, an aroma substitute oil containing 3% by mass or less of a polycyclic aromatic (PCA) component in accordance with the IP 346 method is preferred. Examples of the aroma substitute oil include TDAE (Treated Distillate Aromatic Extracts) and MES (Mild Extraction Solvate) described in Kautschuk Gummi Kunststoffe 52 (12) 799 (1999), and RAE (Residual Aromatic Extracts).

[Method for Producing Molded Bale of Rubber Composition]

A method for producing a molded bale of a rubber composition of the present embodiment includes: a step of obtaining a rubber-like polymer (A) by polymerizing at least a conjugated diene-based monomer in a solution; a step of adding aluminum (B), and nickel and/or cobalt (C) to the resultant solution containing the rubber-like polymer (A) to obtain a rubber composition; and a step of molding the rubber composition.

The nickel and/or cobalt (C) works as a catalyst preferably in a solution, and a hydrogenation reaction occurs in a double bond portion remaining after polymerization of conjugated diene, and hence, a reaction for changing some double bonds into a single bond occurs.

In polymerization process of the rubber-like polymer (A) of the present embodiment, if an aluminum compound is added before hydrogenation process, an amount to be added, in terms of aluminum metal, is preferably 300 ppm or less from the viewpoint that the amount can be easily adjusted to an amount of the metal necessary in process following the polymerization, and from the viewpoint of economic efficiency. The amount is more preferably 200 ppm or less, further preferably 100 ppm or less, and still further preferably 80 ppm or less.

In the polymerization process of the rubber-like polymer (A), if a nickel and/or cobalt compound is added before the hydrogenation process, an amount to be added, in terms of nickel and/or cobalt metal, is preferably 300 ppm or less from the viewpoint that the amount can be easily adjusted to an amount of the metal necessary in process following the polymerization, and from the viewpoint of economic efficiency. The amount is more preferably 200 ppm or less, further preferably 100 ppm or less, and still further preferably 80 ppm or less.

(Addition of Additives)

After the polymerization process of the rubber-like polymer (A) and the hydrogenation process, a deactivating agent, a neutralizer or the like is preferably added from the viewpoint that the amount of metal in the rubber composition of the present embodiment can be thus easily adjusted to a prescribed range.

Examples of the deactivating agent include, but are not limited to, water; and alcohols such as methanol, ethanol, and isopropanol.

Examples of the neutralizer include, but are not limited to, carboxylic acids such as stearic acid, oleic acid, and versatic acid (a carboxylic acid mixture having 9 to 11 carbon atoms, mainly 10 carbon atoms, and having many branches); an aqueous solution of an inorganic acid, and carbon dioxide gas.

After the polymerization process of the rubber-like polymer (A), a rubber stabilizer is preferably added from the viewpoints of prevention of gel formation and processing stability.

As the rubber stabilizer, any of known stabilizers, not limited to the following, can be used, and antioxidants such as 2,6-di-tert-butyl-4-hydroxytoluene (hereinafter sometimes referred to as “BHT”), n-octadecyl-3-(4′-hydroxy-3′,5′-di-tert-butylphenol)propionate, and 2-methyl-4,6-bis[(octylthio)methyl]phenol are preferred.

To the rubber composition of the present embodiment, various additives can be further added if necessary.

As such additives, a filler described below, or a resin component or the like used as a tackifier can be added as a master batch in process performed before molding. In this case, the amount of the additive is preferably 15% by mass or less.

In the rubber composition of the present embodiment, from the viewpoint of making cold flow difficult to occur and the rubber composition difficult to peel off from the molded bale, from the viewpoint of assuring easy adhesion of a packaging sheet to the molded bale, and from the viewpoint of improving balance therebetween, a total content of the rubber-like polymer (A), the aluminum (B), the nickel and/or cobalt (C), and the rubber softener (D) is preferably 85% by mass or more, more preferably 95% by mass or more, and further preferably 97% by mass or more.

In producing the rubber composition of the present embodiment, the step of polymerizing the rubber-like polymer (A) in a solution is performed, and then, the solvent is removed from the polymer solution.

An example of a method for removing the solvent from the polymer solution includes a method using flushing, steam stripping, a drying conveyer after dehydrogenation, a devolatilizing extruder, a drum dryer, or a devolatilizing kneader.

From the viewpoints that thermal history is small and that the amount of metal in the rubber composition can be easily adjusted to a desired amount, a method using at least steam stripping is preferred. In particular, a rubber-like polymer (A) using a coupling agent containing a nitrogen atom is difficult to adjust the amount of metal therein, and hence, the method using steam stripping is useful from the viewpoint of adjustment of the amount of metal.

Examples of a steam stripping method and a method of a treatment performed before or after include, but are not limited to, methods described in Japanese Patent Laid-Open Nos. 10-168101 and 10-204136, International Publication No. WO2013/146530, Japanese Patent Laid-Open No. 2019-131810 and the like.

In the method for producing a rubber composition of the present embodiment, at a previous stage of performing an extruding/drying step, a step of desolvating a solvent from the polymer solution by steam stripping, and a screening step of taking out, from a slurry of the polymer, a water-containing crumb by separating from stripping water are preferably performed.

In a previous stage of the steam stripping, a flushing step may be performed for increasing the concentration of the solution.

When the desolvating step of removing the solvent from the polymer solution by steam stripping is performed at a previous stage of the extruding/drying step, a slurry in which porous granular crumbs not containing the solvent but containing water are dispersed in hot water is obtained.

When the screening step of taking out, from the slurry of the polymer, the water-containing crumb by separating from stripping water is performed, a porous granular crumb containing water can be obtained. Besides, a squeezing dehydration step for performing dehydration with a roll, a screw compression squeezer or the like is preferably performed if necessary. Through such a dehydration step, a water-containing crumb in which the water content has been reduced can be obtained at the previous stage of the extruding/drying step.

As a method for appropriately adjusting, by steam stripping, the content of the aluminum (B) and the content of the nickel and/or cobalt (C) in the rubber composition of the present embodiment, the solution of the rubber-like polymer (A) after polymerization is contacted with hot water or steam under conditions adjusted by employing, as a useful method, a method in which a pressure for charging the solution is adjusted, a method in which a pressure, a temperature and an amount of steam are adjusted, a method in which a dispersant such as a phosphoric acid ester or a salt thereof like polyoxyalkylene alkyl ether phosphate, or a surfactant such as nonyl phenoxy polyethylene glycol phosphate or a salt thereof is added to steam, or a method in which the shape or the rotation speed of a rotor used in mixing are adjusted.

In the production of the rubber composition of the present embodiment, for economic efficiency and removability of metal, it is preferable to contain an alcohol compound in the polymer solution as a deactivating agent, and it is more preferable to precedently add a dispersant or a surfactant to be added in steam stripping.

As a method to be employed in a case where the content of the aluminum (B), and further the content of the nickel and/or cobalt (C) in the rubber composition of the present embodiment are to be reduced, for example, a method in which an alcohol compound is precedently contained as a deactivating agent in the polymer solution, or a method in which a surfactant is added to the polymer solution or steam with a processing rate reduced and with the amount of steam increased can be employed.

A pressure and a linear velocity of a rotor employed in the steam stripping step can be appropriately adjusted by known methods.

After the steam stripping, as described in International Publication No. WO2013/146530, a method for subjecting the resultant rubber composition to drying by extrusion and drying with hot air is preferably performed.

In this manner, a porous granular crumb can be obtained.

A particle size of the crumb is preferably 0.1 mm or more, and more preferably 0.5 mm or more from the viewpoint of obtaining release resistance of the rubber composition from the molded bale, and from the viewpoint of scattering resistance obtained in drying.

On the other hand, the particle size of the crumb is preferably 30 mm or less, and more preferably 20 mm or less from the viewpoints of a drying property of the solvent remaining in the crumb and the water, and swelling resistance of a molded article obtained by molding the rubber composition.

As a method for adjusting the particle size of the crumb, the particle size may be adjusted during process where the solvent is removed and the crumb is dried, or may be adjusted by processing the produced crumb.

When the particle size is adjusted during process where the solvent is removed and the crumb is dried, a method to be employed is not especially limited, and for example, a method in which the molecular weight, the composition or the structure of the rubber-like polymer (A) is adjusted, a method in which the amount of the rubber softener (D) to be added to the solution of the rubber-like polymer (A) is adjusted, a method in which a hole size of a die of an extrusion dryer is adjusted, or a method in which conditions for desolvation performed with the solution of the rubber-like polymer (A) put in hot water are adjusted can be employed.

When the particle size is adjusted by processing the produced crumb, a method to be employed is not especially limited, and for example, a method in which the crumb is sieved, or a method in which the crumb is ground and crushed with a mixer or a granulator can be employed.

A specific surface area of the crumb of the rubber-like polymer (A) or the rubber composition of the present embodiment is preferably 0.7 to 3.2 m²/g, and more preferably 1.0 to 3.0 m²/g from the viewpoint of handleability.

When the specific surface area of the crumb is 0.7 m²/g or more, an area where one crumb is in close contact with other crumbs present around a molded article, in molding, is increased, and hence the crumb is difficult to peel off from the molded article. When the specific surface area of the crumb is 3.2 m²/g or less, crumb particles are compressed at a high density to reduce gaps among the crumbs, and hence expansion of the molded article can be inhibited.

A method for adjusting the specific surface area of the crumb to fall in the above-described range is not especially limited, and for example, a method in which the crumbs are sieved to adjust the composition of each group of sieved crumbs can be employed.

The amount of the solvent remaining in the rubber composition of the present embodiment is preferably smaller from the viewpoints of an odor and VOC reduction. The amount is preferably 5,000 ppm or less, more preferably 3,000 ppm or less, and further preferably 1,500 ppm or less. From the viewpoint of balance in economic efficiency, the amount is preferably 50 ppm or more, more preferably 150 ppm or more, and further preferably 300 ppm or more.

(Water Content of Rubber Composition Contained in Molded Bale)

The rubber composition contained in the molded bale of the present embodiment has a water content of preferably 0.05% by mass or more and 1.5% by mass or less.

The water content of the rubber composition is preferably 0.05% by mass or more from the viewpoint of inhibiting gelation in drying after solvent removal. The water content is more preferably 0.1% by mass or more, and further preferably 0.2% by mass or more. On the other hand, from the viewpoints of preventing condensation and discoloration resistance of the rubber composition, the water content is preferably 1.5% by mass or less, more preferably 1.0% by mass or less, and further preferably 0.8% by mass or less.

The water content of the rubber composition contained in the molded bale of the present embodiment can be controlled to fall in the above-described numerical range by adjusting the shape of the crumb and the conditions for drying process described above.

[Molded Bale]

The molded bale of the present embodiment is a molded article of the rubber composition of the present embodiment described above, and is a molded article in the shape of a block from the viewpoint of handleability.

The molded bale of the present embodiment is preferably a molded article in the shape of a block (bale) of 1,000 cm³ or more. The molded bale is more preferably a rectangular parallelepiped bale of 10 kg to 35 kg.

The molded bale can be molded by a method in which a crumb is compressed, or a method in which sheets are produced and stacked to be compressed, and a preferable molding method is a method in which crumbs having a specific surface area of 0.7 m²/g to 3.2 m²/g are produced, and the resultant crumbs are compression molded. From the viewpoint of moldability, it is preferable to further perform a step of sieving the crumbs before molding.

Since the crumbs are in close contact with one another in the compression molding of the crumbs, a specific surface area of the molded article is small as compared with the specific surface area of the crumbs. The close contact among the crumbs in the compression molding can be adjusted in accordance with the molecular weight, the composition and the structure of the rubber-like polymer (A), the composition of the rubber softener, and a temperature and a pressure employed in the compression. For example, if the specific surface area of the bale is to be reduced by increasing the close contact among the crumbs, it is preferable to employ a condition of reducing the molecular weight of the rubber-like polymer (A), increasing the amount of the rubber softener, or increasing the temperature and the pressure in the compression.

The specific surface area of the molded bale of the present embodiment is preferably 0.005 to 0.05 m²/g, and more preferably 0.01 to 0.04 m²/g from the viewpoint of a film packaging property. The specific surface area of the molded bale is preferably 0.005 m²/g or more because expansion of the bale can be thus inhibited, and the specific surface area of the molded bale is preferably 0.05 m²/g or less because the crumbs peeling off from the molded bale can be thus reduced.

The specific surface area of the molded bale can be obtained by a BET method.

In general, the specific surface area of a big molded bale tends to be varied depending on the position, and hence, the specific surface area is preferably obtained in a portion near the center of the molded bale.

The crumbs of the rubber composition of the present embodiment are preferably sieved into respective particle sizes, before being molded into the molded bale, to be mixed in an appropriate quantitative ratio.

If the specific surface area of the molded bale molded by directly using the crumbs resulting from the desolvation is over the upper limit of the above-described range, it is preferable to increase, among the sieved crumbs, a composition of crumbs having a large particle size and to reduce a composition of crumbs having a small particle size. If the specific surface area is smaller than the lower limit, it is preferable to reduce the composition of crumbs having a large particle size and to increase the composition of crumbs having a small particle size.

A compression pressure for molding the molded bale of the present embodiment is preferably 3 to 30 MPa, and more preferably 10 to 20 MPa. When the compression pressure in the molding is 30 MPa or less, an apparatus to be used can be designed to be compact, and hence installation efficiency is high. When the compression pressure in the molding is 3 MPa or more, good moldability is obtained.

When good moldability is obtained, there is a tendency that the surface of the molded bale is smooth, that the polymer is not peeled off in process following the molding, and that expansion otherwise caused after the molding is inhibited.

A temperature of the rubber composition in the molding is preferably 30 to 120° C., and from the viewpoints of reducing a residual solvent and inhibiting thermal deterioration, is more preferably 50 to 100° C.

The temperature of the rubber composition in the molding is preferably 30° C. or more because good moldability is thus obtained, and on the other hand, the temperature is preferably 120° C. or less because gel formation otherwise caused by thermal deterioration of the rubber composition can be thus inhibited.

As the temperature and the pressure in the molding are higher, the specific surface area of the resultant molded bale tends to be smaller.

A pressure holding time in the molding is preferably 3 to 30 seconds, and more preferably 5 to 20 seconds. When the pressure holding time in the molding is 30 seconds or less, good production efficiency is obtained, and when it is 5 seconds or more, good moldability is obtained.

In order to avoid molded bales from coming to close contact with one another, the molded bale of the present embodiment is preferably packaged in a resin film (packaging sheet).

As the resin of the film, for example, polyethylene, an ethylene copolymer resin, polystyrene, high impact polystyrene, or PET can be used.

From the viewpoints of handleability of the molded article during transport, and difficulty in occurrence of condensation between the packaging sheet and the molded bale, the packaging sheet preferably has good adhesiveness to the molded bale.

The molded bale of the present embodiment is used, for example, to be contained in a vessel for transport. An expansion rate of the molded bale obtained 1 day after the molding is preferably less than 5% because the molded bale can be thus satisfactorily held in the vessel.

[Rubber Composition for Crosslinking]

Since the rubber composition of the molded bale of the present embodiment has high mechanical strength and the like, when a rubber composition for crosslinking is produced by adding a crosslinking agent thereto to obtain a crosslinked product by crosslinking, which can be used in various applications.

The rubber composition for crosslinking of the present embodiment contains at least the rubber composition of the present embodiment described above, and a crosslinking agent, and can further contain, if necessary, an additional rubber component, a filler and the like.

The additional rubber component is not especially limited, and can be appropriately selected depending on purposes. Examples include a styrene-butadiene rubber (of emulsion polymerization type or solution polymerization type), a natural rubber, polyisoprene, a butadiene rubber, an acrylonitrile-butadiene rubber (NBR), a chloroprene rubber, an ethylene-propylene rubber (EPM), an ethylene-propylene-non-conjugated diene rubber (EPDM), a butyl rubber, a polysulfide rubber, a silicone rubber, a fluororubber, and a urethane rubber. One of these may be singly used, or a mixture of two or more of these may be used.

A content of the rubber-like polymer (A) with respect to a total rubber component content corresponding to a total amount of the rubber-like polymer (A) and the additional rubber component in the rubber composition for crosslinking of the present embodiment is preferably 20% by mass or more, more preferably 40% by mass or more, further preferably 60% by mass or more, and still further preferably 80% by mass or more from the viewpoint of exhibiting the effects of the present invention.

To the rubber composition for crosslinking of the present embodiment, a filler can be added if necessary for purposes of improving a reinforcing property and the like.

An amount of the filler to be blended is not especially limited, can be appropriately selected depending on purposes, and is preferably 10 to 100 parts by mass, and more preferably 20 to 80 parts by mass with respect to 100 parts by mass of the rubber component corresponding to the total amount of the rubber-like polymer (A) and the additional rubber component.

When the amount of the filler to be blended is 10 parts by mass or more, the effect of improving a reinforcing property resulting from blending the filler can be obtained. When the amount is 100 parts by mass or less, good processability can be retained with avoiding large deterioration of fuel economy caused in the form of a tire.

The filler is not especially limited, and examples include carbon black, silica, aluminum hydroxide, clay, alumina, talc, mica, kaolin, glass balloon, glass bead, calcium carbonate, magnesium carbonate, magnesium hydroxide, magnesium oxide, titanium oxide, potassium titanate, and barium sulfate. Among these, carbon black is preferably used. One of these may be singly used, or two or more of these may be used together.

The carbon black is not especially limited, and can be appropriately selected depending on purposes, and examples include FEF, GPF, SRF, HAF, N339, IISAF, ISAF, and SAF. One of these may be singly used, or two or more of these may be used together.

A nitrogen adsorption specific surface area (N2SA, measured in accordance with JIS K6217-2: 2001) of the carbon black is not especially limited, and can be appropriately selected depending on purposes.

When the rubber composition for crosslinking of the present embodiment is used as a composition for a fuel efficient tire tread, precipitated silica is suitably used as the filler.

The rubber composition for crosslinking of the present embodiment may contain a silane coupling agent from the viewpoints of improvement of dispersibility of the filler and tensile physical strength of the cross linked product.

The silane coupling agent is preferably a compound that has a function to make close the interaction between the rubber component and the inorganic filler, has a group having affinity with or a binding property to each of the rubber component and a silica-based inorganic filler, and contains, in one molecule, a sulfur bond portion and an alkoxysilyl group or silanol group portion.

Examples of such a compound include, but are not limited to, bis-[3-(triethoxysilyl)-propyl]-tetrasulfide, bis-[3-(triethoxysilyl)-propyl]-disulfide, bis-[2-(triethoxysilyl)-ethyl]-tetrasulfide, S-[3-(triethoxysilyl)-propyl]octanethioate, a condensate of S-[3-(triethoxysilyl)-propyl]octanethioate and [(triethoxysilyl)-propyl]thiol, and a silane carrying at least one thiol (—SH) functional group (referred to as mercaptosilane) and/or at least one masked thiol group.

A content of the silane coupling agent in the rubber composition for crosslinking of the present embodiment is preferably 0.1 parts by mass or more and 30 parts by mass or less, more preferably 0.5 parts by mass or more and 20 parts by mass or less, and further preferably 1.0 part by mass or more and 15 parts by mass or less with respect to 100 parts by mass of the filler. When the content of the silane coupling agent falls in this range, there is a tendency that the effect attained by the addition of the silane coupling agent can be made further remarkable.

The rubber composition for crosslinking of the present embodiment contains the crosslinking agent.

The crosslinking agent is not especially limited, and can be appropriately selected depending on purposes. Examples include a sulfur-based crosslinking agent, an organic peroxide-based crosslinking agent, an inorganic crosslinking agent, a polyamine crosslinking agent, a resin crosslinking agent, a sulfur compound-based crosslinking agent, and an oxime-nitrosamine-based crosslinking agent. Any of these may be used together.

As a rubber composition for a tire, a sulfur-based crosslinking agent (vulcanizing agent) is more preferred among these, and in particular, sulfur is further preferred.

A content of the crosslinking agent in the rubber composition for crosslinking of the present embodiment is 0.1 parts by mass or more and 20 parts by mass or less with respect to 100 parts by mass of the rubber component. The content of the crosslinking agent is preferably 0.1 parts by mass or more, more preferably 0.5 parts by mass or more, and further preferably 1.5 parts by mass or more with respect to 100 parts by mass of the rubber component from the viewpoints of high tensile strength and a high crosslinking speed. On the other hand, from the viewpoints of inhibition of uneven crosslinking and high tensile strength, the content is preferably 20 parts by mass or less, more preferably 5 parts by mass or less, and further preferably 3 parts by mass or less.

It is noted that the rubber component contains the rubber-like polymer (A), and the additional rubber component.

In the rubber composition for crosslinking of the present embodiment, a vulcanization accelerator may be used in addition to the vulcanizing agent.

Examples of the vulcanization accelerator include guanidine-based, aldehyde-amine-based, aldehyde-ammonia-based, thiazole-based, sulfenamide-based, thiourea-based, thiuram-based, dithiocarbamate-based, and xanthate-based compounds.

In the rubber composition for crosslinking of the present embodiment, in addition to the above-described components, various additives such as an additional softener, an additional filler, a heat stabilizer, an antistatic agent, a weathering stabilizer, an anti-aging agent, a colorant, and a lubricant may be used.

As the additional softener, any of known softeners can be used.

Examples of the additional filler include calcium carbonate, magnesium carbonate, aluminum sulfate, and barium sulfate.

As the heat stabilizer, the antistatic agent, the weathering stabilizer, the anti-aging agent, the colorant, and the lubricant, any of known materials can be respectively used.

(Kneading Method for Rubber Composition for Crosslinking)

The rubber composition for crosslinking of the present embodiment can be produced by mixing the rubber composition of the present embodiment described above, the crosslinking agent, and if necessary, the silica-based inorganic filler, the carbon black and another filler, the silane coupling agent, and various additives such as the rubber softener.

Examples of a mixing method include, but are not limited to, a melt kneading method using a general mixer such as an open roll, a Banbury mixer, a kneader, a single screw extruder, a double screw extruder, or a multi-screw extruder, and a method in which the respective components are dissolved to be mixed, and then a solvent is removed by heating.

Among these, a melt kneading method using a roll, a Banbury mixer, a kneader or an extruder is preferred from the viewpoints of productivity and good kneadability.

Besides, either of a method in which the rubber component, and the other components of the filler, the silane coupling agent and the additives are kneaded all at once, and a method in which these are mixed dividedly plural times can be employed.

[Application of Rubber Composition and Rubber Composition for Crosslinking]

The rubber composition and the rubber composition for crosslinking of the present embodiment are applicable to, for example, tire members, interiors and exteriors of vehicles, anti-vibration rubbers, belts, shoes, foam materials, and various industrial products.

In particular, the rubber composition and the rubber composition for crosslinking are suitably used in tire members.

As the tire members, these compositions can be used in, for example, various tires such as a fuel efficient tire, an all-season tire, a high performance tire, a snow tire, and a studless tire; and various portions of a tire such as a tread, a carcass, a sidewall, and a bead portion. In particular, these compositions are excellent, in the form of a vulcanizate, in balance among abrasion resistance, fuel economy, wet skid resistance, and snow performance, and therefore, are suitably used, as the tire member, for a tire tread of a fuel efficient tire, a high performance tire, or a snow tire.

As a method for producing a tire, any of common methods can be employed. For example, members usually used for production of a tire, such as a carcass layer, a belt layer, and a tread layer containing at least one selected from the group consisting of a rubber composition for crosslinking before vulcanization and a tire cord, are successively overlayed on a tire forming drum to adhere to one another, and the drum is pulled out to obtain a green tire. Subsequently, the green tire is vulcanized by heating by an ordinary method, and thus, a desired tire (such as a pneumatic tire) can be produced.

### EXAMPLES

The present embodiment will now be described in more detail with reference to specific Examples and Comparative Examples, and it is noted that the present embodiment is not limited to the following Examples and Comparative Examples at all.

Various physical properties of the Examples and Comparative Examples were measured by the following methods.

[Physical Properties of Rubber-Like Polymer (A)]

(Weight Average Molecular Weight (Mw) of Rubber-Like Polymer (A) Before Hydrogenation)

A chromatogram was measured with a GPC measuring apparatus including a series of three columns using a polystyrene-based gel as a filler, and a weight average molecular weight (Mw) of a rubber-like polymer before hydrogenation was obtained based on a calibration curve obtained using standard polystyrene.

As an eluent, THF containing 5 mmol/L triethylamine was used.

As columns, a guard column: trade name “TSKguardcolumn Super H-H” manufactured by Tosoh Corporation, and columns: trade names “TSKgel Super H5000”, “TSKgel Super H6000”, and “TSKgel Super H7000” manufactured by Tosoh Corporation were used.

Under conditions of an oven temperature of 40° C. and a THF flow rate of 0.6 mL/min, an RI detector (trade name “HLC8020” manufactured by Tosoh Corporation) was used. A measurement solution was prepared by dissolving 10 mg of a measurement sample in 20 mL of THF, and 20 μL of the measurement solution was injected into the GPC measuring apparatus for measurement.

(Polymer Mooney Viscosity of Rubber-Like Polymer (A) Before Hydrogenation)

A rubber-like polymer before hydrogenation was used as a sample to measure a Mooney viscosity with a Mooney viscometer (trade name “VR1132” manufactured by Ueshima Seisakusho Co., Ltd.) using an L rotor in accordance with ISO 289.

A measurement temperature was set to 100° C.

First, a sample was preheated for 1 minute at the test temperature, the rotor was rotated at 2 rpm, and torque was measured after 4 minutes to be defined as a Mooney viscosity (ML_{(1,4)}).

(Modification Ratio of Rubber-Like Polymer (A))

A modification ratio was measured by column adsorption GPC as follows by utilizing a characteristic that a rubber-like polymer modified with a nitrogen atom-containing functional group adsorbs on a column.

A sample solution containing a rubber-like polymer and low molecular weight internal standard polystyrene was measured for an amount of adsorption to a silica-based column based on a difference between a chromatogram measured with a polystyrene-based column and a chromatogram measured with a silica-based column, and thus, a modification ratio was obtained.

Specifically, the measurement was performed as follows.

Preparation of Sample Solution:

A sample solution was prepared by dissolving 10 mg of the rubber-like polymer and 5 mg of standard polystyrene in 20 mL of THF.

GPC Measurement Conditions using Polystyrene-based Column:

THF containing 5 mmol/L of triethylamine was used as an eluent, and 20 μL of the sample solution was injected into an apparatus for measurement. As columns, a guard column: trade name “TSKguardcolumn Super H-H” manufactured by Tosoh Corporation and columns: trade names “TSKgel Super H5000”, “TSKgel Super H6000”, and “TSKgel Super H7000” manufactured by Tosoh Corporation were used. Under conditions of an oven temperature of 40° C. and a THF flow rate of 0.6 mL/min, an RI detector (trade name “HLC8020” manufactured by Tosoh Corporation) was used for the measurement to obtain a chromatogram.

GPC Measurement Conditions Using Silica-Based Column:

An apparatus, trade name “HLC-8320GPC” manufactured by Tosoh Corporation was used, THF was used as an eluent, and 50 μL of a sample solution was injected into the apparatus. Under conditions of an oven temperature of 40° C. and a THF flow rate of 0.5 mL/min, an RI detector was used to obtain a chromatogram. As columns, trade names “Zorbax PSM-1000S”, “PSM-3005”, and “PSM-60S” in series were used, and a column, trade name “DIOL 4.6×12.5 mm 5 micron” was connected as a guard column at a previous stage.

Calculation Method for Modification Ratio:

A modification ratio (%) was obtained in accordance with the following equation assuming that a whole peak area of the chromatogram obtained with the polystyrene-based column is 100, that a peak area of the sample is P1, that a peak area of the standard polystyrene is P2, that a whole peak area of the chromatogram obtained with the silica-based column is 100, that a peak area of the sample is P3, and that a peak area of the standard polystyrene is P4:

Modification Ratio (%)=[1−(P2×P3)/(P1×P4)]×100

wherein P1+P2=P3+P4=100.

(Amount of Bound Styrene in Rubber-Like Polymer (A) Before Hydrogenation)

As a sample, 100 mg of a rubber-like polymer (A) before hydrogenation was dissolved and diluted to 100 mL of chloroform to obtain a measurement sample. An amount of absorption by a phenyl group of styrene at an ultraviolet absorption wavelength (about 254 nm) was used to measure an amount of bound styrene (% by mass) with respect to 100% by mass of the rubber-like polymer before hydrogenation used as the sample.

As a measuring apparatus, a spectrophotometer “UV-2450” manufactured by Shimadzu Corporation was used.

(Microstructure of Butadiene Portion (1,2-Vinyl Bond Content) of Rubber-Like Polymer (A) Before Hydrogenation)

As a sample, 50 mg of a rubber-like polymer (A) before hydrogenation was dissolved in 10 mL of carbon disulfide to obtain a measurement sample.

An infrared spectrum was measured in a range of 600 to 1000 cm⁻¹ with a solution cell used, and based on an absorbance at a prescribed wavelength, a microstructure of a butadiene portion, namely, a 1,2-vinyl bond content (% by mol), was obtained in accordance with an equation of Hampton's method (a method described in R. R. Hampton, Analytical Chemistry 21, 923 (1949)).

As a measuring apparatus, a Fourier transform infrared spectrophotometer “FT-IR230” manufactured by JASCO Corporation was used.

(Content of Styrene Block in Rubber-Like Polymer (A))

Assuming that a chain of eight or more styrene structure units is defined as a styrene block, the content was obtained as follows.

Based on a ¹H-NMR spectrum at 400 MHz measured with deuterated chloroform used as a solvent, a ratio of an integrated value of the following (a) in each chemical shift range was obtained, and thus, the content of the styrene block contained in the rubber-like polymer was obtained.

(a) Chain of Eight or More Aromatic Vinyl Compounds: 6.00≤S<6.68

(Iodine Value of Rubber-Like Polymer (A))

The iodine value of a rubber-like polymer (A) was calculated in accordance with a method described in “JIS K 0070: 1992”.

(Amount of Bound Styrene (after hydrogenation), Ethylene Structure, and Conjugated Diene Monomer Unit in Rubber-like Polymer (A))

A rubber-like polymer (A) was used as a sample to measure, by ¹H-NMR measurement, an amount of bound styrene, ethylene structure, and conjugated diene monomer unit. Measurement conditions for the ¹H-NMR measurement were as follows:

<Measurement Conditions>

Apparatus: JNM-LA400 (manufactured by JEOL Ltd.)

Solvent: deuterated chloroform

Measurement sample: rubber-like polymer

Sample concentration: 50 mg/mL

Observation frequency: 400 MHz

Chemical shift reference: TMS (tetramethylsilane)

Pulse delay: 2.904 sec

Number of scans: 64

Pulse width: 45°

Measurement temperature: 26° C.

[Physical Properties of Rubber Composition]

(Metal Contents (Al Content, Ni, Content, Co Content, and Ti Content) in Rubber Composition)

A rubber composition obtained in each of the Examples and Comparative Examples described below was measured, through elemental analysis using inductivity coupled plasma (ICP, Inductively Coupled Plasma, name of apparatus: ICPS-7510, manufactured by Shimadzu Corporation), for an aluminum content (Al content, in ppm), a nickel content (Ni content, in ppm), a cobalt content (Co content, in ppm), and a titanium content (Ti content, in ppm) in the rubber-like polymer.

(Water Content of Rubber Composition)

A water content of a rubber composition was obtained by putting 50 g of the rubber composition in a hot air dryer heated to 150° C. to be dried for 3 hours to measure a mass difference of the rubber composition caused by the drying.

[Evaluation of Molded Article of Rubber Composition]

(Method for Desolvating Rubber Composition Solution)

<Desolvation Conditions 1>

Assuming steam stripping, a 50 L vessel was charged with 20 L of hot water at 90° C., and under stirring at a rotation speed of 1,000 rpm with a homogenizer (Homo Mixer MARK II (trade name, manufactured by Primix Corporation, 0.2 kW)), a polymer solution was added thereto in a dropwise manner for 30 minutes at a rate of 200 g/min. After completing the dropwise addition, the stirring was continued for 30 minutes, and thus, desolvation was performed. A crumb of the rubber composition generated in the hot water was dried to obtain a crumb of the rubber composition.

<Desolvation Conditions 2>

Assuming steam stripping, a 50 L vessel was charged with 20 L of hot water at 90° C., and under stirring at a rotation speed of 6,000 rpm with a homogenizer (Homo Mixer MARK II (trade name, manufactured by Primix Corporation, 0.2 kW)), a polymer solution was added thereto in a dropwise manner for 30 minutes at a rate of 200 g/min. After completing the dropwise addition, the stirring was continued for 30 minutes, and thus, desolvation was performed. A crumb of the rubber composition generated in the hot water was dried to obtain a crumb of the rubber composition.

<Desolvation Conditions 3>

Assuming steam stripping, a 50 L vessel was charged with 20 L of hot water at 90° C., and under stirring at a rotation speed of 12,000 rpm with a homogenizer (Homo Mixer MARK II (trade name, manufactured by Primix Corporation, 0.2 kW)), a polymer solution was added thereto in a dropwise manner for 30 minutes at a rate of 200 g/min. After completing the dropwise addition, the stirring was continued for 30 minutes, and thus, desolvation was performed. A crumb of the rubber composition generated in the hot water was dried to obtain a crumb of the rubber composition.

(Method for Molding Bale of Rubber Composition)

The crumb prepared as described above was warmed to 60° C., then filled in a rectangular parallelepiped vessel having a length of 210 mm, a width of 105 mm, and a depth of 200 mm, and compressed by applying a pressure of 3.5 MPa with a cylinder over 10 seconds to obtain a bale of the rubber composition.

(Evaluation: Cold Flow Property of Molded Article of Rubber Composition)

The bale molded under the above-described conditions was used, a load of 5 kg was applied thereto at an ambient temperature of 25° C. and a humidity of 50%, and allowed to stand for 72 hours to measure a thickness (H60), and a ratio (%) of thickness change was calculated in accordance with the following equation:

Ratio (%) of thickness change=(H0−H60)×100/H0

wherein H0 indicates a thickness of the bale obtained immediately after molding.

A smaller ratio of thickness change (index) indicates that cold flow of the rubber bale in storage is small and handleability is excellent.

An index less than 10 was evaluated as ⊚, an index of 10 or more and less than 20 was evaluated as ◯, an index of 20 or more and less than 40 was evaluated as Δ, and an index of 40 or more was evaluated as X.

For practical use, the index needs to be less than 40, and is preferably less than 20.

(Evaluation: Thermal Deterioration)

Thermal deterioration was evaluated by measuring change of an oxidation starting temperature caused by applying a thermal load.

A main body temperature of Lab Plast Mill 30C150 (manufactured by Toyo Seiki Seisaku-sho, Ltd.) was set to 50° C., and 50 g of a rubber composition was put therein to be subjected to 3 cycles of kneading in total, in each cycle of which kneading is performed at 120 rpm for 5 minutes and halted for 5 minutes.

The oxidation starting temperature of the rubber composition was measured before and after the kneading with a thermogravimetry/differential thermal analyzer (STA 7200RV, manufactured by Hitachi).

In air atmosphere, the temperature was increased from 30° C. to 500° C. at 10° C./min, and a temperature at which an endothermic peak was found was defined as the oxidation starting temperature. A difference in the oxidation starting temperature of the rubber composition caused by applying a thermal load was determined as ΔT to be used as an index of thermal deterioration.

As the ΔT is smaller, the rubber composition is better in thermal deterioration, which is preferable because deterioration due to heat of physical properties can be inhibited.

A ΔT of 0° C. or more and less than 5° C. was evaluated as ⊚, a ΔT of 5° C. or more and less than 8° C. was evaluated as ◯, a ΔT of 8° C. or more and less than 12° C. was evaluated as Δ, and a ΔT of 12° C. or more was evaluated as X. For a practical use, the ΔT needs to be less than 12° C., and is preferably less than 8° C.

[Preparation of Hydrogenation Catalyst, Rubber-Like Polymer (A), and Rubber Composition]

(Preparation of Hydrogenation Catalyst)

A hydrogenation catalyst used in preparing a rubber-like polymer in each of the Examples and Comparative Examples described below was prepared as follows.

### Production Example 1

A nitrogen-substituted reaction vessel was charged with 1 L of dried and purified cyclohexane, and 100 mmol of nickel octylate and 200 mmol of trimethyl aluminum were added thereto to obtain a hydrogenation catalyst, a Ziegler catalyst (NA-1).

### Production Example 2

A nitrogen-substituted reaction vessel was charged with 1 L of dried and purified cyclohexane, and 100 mmol of bis(η5-cyclopentadienyl)titanium dichloride was added thereto. Under sufficient stirring, a n-hexane solution containing 200 mmol of trimethyl aluminum was added thereto to be reacted for about 3 days at room temperature, and thus, a hydrogenation catalyst (TC-1) was obtained.

(Polymerization of Rubber-like Polymer (A) before Hydrogenation)

### (Polymerization Example 1) Rubber-Like Polymer (S) Before Hydrogenation

A temperature-controllable autoclave having an internal capacity of 40 L and equipped with a stirrer and a jacket was used as a reactor. The reactor was charged with 2,160 g of 1,3-butadiene, 300 g of styrene, and 21,000 g of cyclohexane, from which impurities had been precedently removed, and 30 mmol of tetrahydrofuran (THF) and 4.9 mmol of 2,2-bis(2-oxolanyl)propane used as polar substances, and the internal temperature of the reactor was kept at 42° C.

As a polymerization initiator, 33.2 mmol of n-butyllithium was supplied to the reactor.

After starting a polymerization reaction, the temperature within the reactor started to increase due to heat generation through polymerization, and after monomer conversion within the reactor reached 98%, 540 g of 1,3-butadiene was added to cause a reaction.

The temperature within the reactor finally reached 76° C. Two minutes after reaching this reaction temperature peak, 4.1 mmol of 2,2-dimethoxy-1-(3-trimethoxysilylpropyl)-1-aza-2-silacyclopentane (compound 1) was added to the reactor to perform a coupling reaction for 20 minutes. To the thus obtained polymer solution, 15.0 mmol of methanol used as a reaction terminator was added to obtain a rubber-like polymer solution (SS) before hydrogenation.

A part of the rubber-like polymer solution (SS) before hydrogenation was extracted to be desolvated with a dryer, and thus, a rubber-like polymer (S) before hydrogenation was obtained.

Analysis results are shown in Table 1.

### (Polymerization Example 2) Rubber-Like Polymer (T) Before Hydrogenation

A temperature-controllable autoclave having an internal capacity of 40 L and equipped with a stirrer and a jacket was used as a reactor. The reactor was charged with 2,100 g of 1,3-butadiene, 780 g of styrene, and 21,000 g of cyclohexane, from which impurities had been precedently removed, and 30 mmol of tetrahydrofuran (THF) and 18.3 mmol of 2,2-bis(2-oxolanyl)propane used as polar substances, and the internal temperature of the reactor was kept at 42° C.

As a polymerization initiator, 26.2 mmol of n-butyllithium was supplied to the reactor.

After starting a polymerization reaction, the temperature within the reactor started to increase due to heat generation through polymerization, and after monomer conversion within the reactor reached 98%, 120 g of 1,3-butadiene was added to cause a reaction.

The temperature within the reactor finally reached 78° C. Two minutes after reaching this reaction temperature peak, 3.3 mmol of N,N′-(1,4-phenylene)bis(4-trimethoxysilyl)butan-1-imine) (compound 2) was added to the reactor to perform a coupling reaction for 20 minutes. To the thus obtained polymer solution, 12.6 mmol of methanol used as a reaction terminator was added to obtain a rubber-like polymer solution (TS) before hydrogenation.

A part of the rubber-like polymer solution (TS) before hydrogenation was extracted to be desolvated with a dryer, and thus, a rubber-like polymer (T) before hydrogenation was obtained.

Analysis results are shown in Table 1.

### (Polymerization Example 3) Rubber-Like Polymer (U) Before Hydrogenation

A temperature-controllable autoclave having an internal capacity of 40 L and equipped with a stirrer and a jacket was used as a reactor. The reactor was charged with 450 g of styrene, and 21,000 g of cyclohexane, from which impurities had been precedently removed, and 30 mmol of tetrahydrofuran (THF) and 13.1 mmol of 2,2-bis(2-oxolanyl)propane used as polar substances, and the internal temperature of the reactor was kept at 45° C.

As a polymerization initiator, 26.2 mmol of n-butyllithium was supplied to the reactor.

After starting a polymerization reaction, the temperature within the reactor started to increase due to heat generation through polymerization, and after monomer conversion within the reactor reached 98%, 2,220 g of 1,3-butadiene was added, and 1 minute after completing the addition, 120 g of styrene was added to cause a reaction.

The temperature within the reactor finally reached 78° C. Two minutes after reaching this reaction temperature peak, 3.3 mmol of 2,2-dimethoxy-1-(3-trimethoxysilylpropyl)-1-aza-2-silacyclopentane (compound 1) was added to the reactor to perform a coupling reaction for 20 minutes. To the thus obtained polymer solution, 12.6 mmol of methanol used as a reaction terminator was added to obtain a rubber-like polymer solution (US) before hydrogenation.

A part of the rubber-like polymer solution (US) before hydrogenation was extracted to be desolvated with a dryer, and thus, a rubber-like polymer (U) before hydrogenation was obtained.

Analysis results are shown in Table 1.

### (Polymerization Example 4) Rubber-Like Polymer (V) Before Hydrogenation

A temperature-controllable autoclave having an internal capacity of 40 L and equipped with a stirrer and a jacket was used as a reactor. The reactor was charged with 3,000 g of 1,3-butadiene, and 21,000 g of cyclohexane, from which impurities had been precedently removed, and 30 mmol of tetrahydrofuran (THF) and 4.7 mmol of 2,2-bis(2-oxolanyl)propane used as polar substances, and the internal temperature of the reactor was kept at 41° C.

As a polymerization initiator, 36.1 mmol of n-butyllithium was supplied to the reactor.

After starting a polymerization reaction, the temperature within the reactor started to increase due to heat generation through polymerization, and the temperature within the reactor finally reached 80° C. Two minutes after reaching this reaction temperature peak, 4.5 mmol of 2,2-dimethoxy-1-(3-trimethoxysilylpropyl)-1-aza-2-silacyclopentane (compound 1) was added to the reactor to perform a coupling reaction for 20 minutes. To the thus obtained polymer solution, 17.3 mmol of methanol used as a reaction terminator was added to obtain a rubber-like polymer solution (VS) before hydrogenation.

A part of the rubber-like polymer solution (VS) before hydrogenation was extracted to be desolvated with a dryer, and thus, a rubber-like polymer (V) before hydrogenation was obtained.

Analysis results are shown in Table 1.

### (Polymerization Example 5) Rubber-Like Polymer (W) Before Hydrogenation

A temperature-controllable autoclave having an internal capacity of 40 L and equipped with a stirrer and a jacket was used as a reactor. The reactor was charged with 2,160 g of 1,3-butadiene, 300 g of styrene, and 21,000 g of cyclohexane, from which impurities had been precedently removed, and 30 mmol of tetrahydrofuran (THF) and 2.9 mmol of 2,2-bis(2-oxolanyl)propane used as polar substances, and the internal temperature of the reactor was kept at 45° C.

As a polymerization initiator, 20.6 mmol of n-butyllithium was supplied to the reactor.

After starting a polymerization reaction, the temperature within the reactor started to increase due to heat generation through polymerization, and after monomer conversion within the reactor reached 98%, 540 g of 1,3-butadiene was added to cause a reaction.

The temperature within the reactor finally reached 76° C. Two minutes after reaching this reaction temperature peak, 4.0 mmol of 2,2-dimethoxy-1-(3-trimethoxysilylpropyl)-1-aza-2-silacyclopentane (compound 1) was added to the reactor to perform a coupling reaction for 20 minutes. To the thus obtained polymer solution, 4.1 mmol of methanol used as a reaction terminator was added to obtain a rubber-like polymer solution (WS) before hydrogenation.

A part of the rubber-like polymer solution (WS) before hydrogenation was extracted to be desolvated with a dryer, and thus, a rubber-like polymer (W) before hydrogenation was obtained.

Analysis results are shown in Table 1.

### (Polymerization Example 6) Rubber-Like Polymer (X) Before Hydrogenation

A temperature-controllable autoclave having an internal capacity of 40 L and equipped with a stirrer and a jacket was used as a reactor. The reactor was charged with 2,160 g of 1,3-butadiene, 300 g of styrene, and 21,000 g of cyclohexane, from which impurities had been precedently removed, and 30 mmol of tetrahydrofuran (THF) and 2.5 mmol of 2,2-bis(2-oxolanyl)propane used as polar substances, and the internal temperature of the reactor was kept at 47° C.

As a polymerization initiator, 18.2 mmol of n-butyllithium was supplied to the reactor.

After starting a polymerization reaction, the temperature within the reactor started to increase due to heat generation through polymerization, and after monomer conversion within the reactor reached 98%, 540 g of 1,3-butadiene was added to cause a reaction.

The temperature within the reactor finally reached 75° C. Two minutes after reaching this reaction temperature peak, 1.6 mmol of 2,2-dimethoxy-1-(3-trimethoxysilylpropyl)-1-aza-2-silacyclopentane (compound 1) was added to the reactor to perform a coupling reaction for 20 minutes. To the thus obtained polymer solution, 11.9 mmol of methanol used as a reaction terminator was added to obtain a rubber-like polymer solution (XS) before hydrogenation.

A part of the rubber-like polymer solution (XS) before hydrogenation was extracted to be desolvated with a dryer, and thus, a rubber-like polymer (X) before hydrogenation was obtained.

Analysis results are shown in Table 1.

(Preparation of Rubber Composition)

### (Example 1) Rubber Composition (SH-1)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (S-1) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (SH-1).

Analysis results and evaluations of the rubber composition, and evaluations of a molded bale are shown in Table 2.

### (Example 2) Rubber Composition (SH-2)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 100 minutes, and thus, a rubber-like polymer (S-2) was obtained. The rubber-like polymer thus obtained had an iodine value of 38.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (SH-2).

Analysis results and evaluations of the rubber composition, and evaluations of a molded bale are shown in Table 2.

### (Example 3) Rubber Composition (SH-3)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 90° C. for 50 minutes, and thus, a rubber-like polymer (S-3) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 2>, and the resultant was dried with a dryer to obtain a rubber composition (SH-3).

Analysis results and evaluations of the rubber composition, and evaluations of a molded bale are shown in Table 2.

### (Example 4) Rubber Composition (SH-4)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 100 ppm per 100 parts by mass of the rubber-like polymer before hydrogenation, followed by a hydrogenation reaction at a hydrogen pressure of 0.8 MPa and an average temperature of 85° C. for 40 minutes, and thus, a rubber-like polymer (S-4) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (SH-4).

Analysis results and evaluations of the rubber composition, and evaluations of a molded bale are shown in Table 2.

### (Example 5) Rubber Composition (SH-5)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 60 minutes, and thus, a rubber-like polymer (S-5) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 3>, and the resultant was dried with a dryer to obtain a rubber composition (SH-5).

Analysis results and evaluations of the rubber composition, and evaluations of a molded bale are shown in Table 2.

### (Example 6) Rubber Composition (TH-1)

To the rubber-like polymer solution (TS) before hydrogenation obtained as described above (Polymerization Example 2), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (T-1) was obtained. The rubber-like polymer thus obtained had an iodine value of 70.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (TH-1).

Analysis results and evaluations of the rubber composition, and evaluations of a molded bale are shown in Table 2.

### (Example 7) Rubber Composition (SH-6)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 100 minutes, and thus, a rubber-like polymer (S-6) was obtained. The rubber-like polymer thus obtained had an iodine value of 38.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants, and simultaneously, 150 g of SRAE oil (JOMO Process NC140, manufactured by JX Nippon Oil & Energy Corporation) was added and mixed. Thereafter, 6,000 g of the resultant rubber composition solution was desolvated by the method described in <Desolvation Conditions 1>, and the resultant was dried with a dryer to obtain a rubber composition (SH-6).

Analysis results and evaluations of the rubber composition, and evaluations of a molded bale are shown in Table 3.

### (Example 8) Rubber Composition (SH-7)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (S-7) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants, and simultaneously, 6 g of stearic acid was added. Thereafter, 6,000 g of the resultant rubber composition solution was desolvated by the method described in <Desolvation Conditions 1>, and the resultant was dried with a dryer to obtain a rubber composition (SH-7).

Analysis results and evaluations of the rubber composition, and evaluations of a molded bale are shown in Table 3.

### (Example 9) Rubber Composition (SH-8)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (S-8) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer but was dried merely for a half the drying time of Example 1 to obtain a rubber composition (SH-8).

Analysis results and evaluations of the rubber composition, and evaluations of a molded bale are shown in Table 3.

### (Example 10) Rubber Composition (TH-2)

To the rubber-like polymer solution (TS) before hydrogenation obtained as described above (Polymerization Example 2), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 40 minutes, and thus, a rubber-like polymer (T-2) was obtained. The rubber-like polymer thus obtained had an iodine value of 129.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (TH-2).

Analysis results and evaluations of the rubber composition, and evaluations of a molded bale are shown in Table 3.

### (Example 11) Rubber Composition (WH-1)

To the rubber-like polymer solution (WS) before hydrogenation obtained as described above (Polymerization Example 5), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (WH-1) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (WH-1).

Analysis results and evaluations of the rubber composition, and evaluations of a molded bale are shown in Table 3.

### (Example 12) Rubber Composition (XH-1)

To the rubber-like polymer solution (XS) before hydrogenation obtained as described above (Polymerization Example 6), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (XH-1) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (XH-1).

Analysis results and evaluations of the rubber composition, and evaluations of a molded bale are shown in Table 3.

### (Comparative Example 1) Rubber Composition (SH-9)

To the rubber-like polymer solution (SS) before hydrogenation obtained as described above (Polymerization Example 1), the hydrogenation catalyst (TC-1) prepared as described above (Production Example 2) was added in an amount, in terms of Ti, of 70 ppm per 100 parts by mass of the rubber-like polymer before hydrogenation, followed by a hydrogenation reaction at a hydrogen pressure of 0.8 MPa and an average temperature of 85° C. for 50 minutes, and thus, a rubber-like polymer (S-9) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (SH-9).

Analysis results and evaluations of the rubber composition, and evaluations of a molded bale are shown in Table 4.

### (Comparative Example 2) Rubber Composition (SH-10)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 180 ppm per 100 parts by mass of the rubber-like polymer before hydrogenation, followed by a hydrogenation reaction at a hydrogen pressure of 0.8 MPa and an average temperature of 90° C. for 40 minutes, and thus, a rubber-like polymer (S-10) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (SH-10).

Analysis results and evaluations of the rubber composition, and evaluations of a molded bale are shown in Table 4.

### (Comparative Example 3) Rubber Composition (SH-11)

To the rubber-like polymer solution (SS) before hydrogenation obtained as described above (Polymerization Example 1), the hydrogenation catalyst (NA-1) prepared as described above (Production Example 1) was added in an amount, in terms of Ni, of 5 ppm per 100 parts by mass of the rubber-like polymer before hydrogenation, and the hydrogenation catalyst (TC-1) prepared as described above (Production Example 2) was added in an amount, in terms of Ti, of 30 ppm per 100 parts by mass of the rubber-like polymer before hydrogenation, followed by a hydrogenation reaction at a hydrogen pressure of 0.9 MPa and an average temperature of 90° C. for 35 minutes, and thus, a rubber-like polymer (S-11) was obtained. The rubber-like polymer thus obtained had an iodine value of 85.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 3>, and the resultant was dried with a dryer to obtain a rubber composition (SH-11).

Analysis results and evaluations of the rubber composition, and evaluations of a molded bale are shown in Table 4.

### (Comparative Example 4) Rubber Composition (TH-3)

To the rubber-like polymer solution (TS) before hydrogenation obtained as described above (Polymerization Example 2), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 40 minutes, and thus, a rubber-like polymer (T-3) was obtained. The rubber-like polymer thus obtained had an iodine value of 209.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (TH-3).

Analysis results and evaluations of the rubber composition, and evaluations of a molded bale are shown in Table 4.

### (Comparative Example 5) Rubber Composition (UH-1)

To the rubber-like polymer solution (US) before hydrogenation obtained as described above (Polymerization Example 3), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.8 MPa and an average temperature of 85° C. for 60 minutes, and thus, a rubber-like polymer (U-1) was obtained. The rubber-like polymer thus obtained had an iodine value of 70.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (UH-1).

Analysis results and evaluations of the rubber composition, and evaluations of a molded article are shown in Table 4.

### (Comparative Example 6) Rubber Composition (VH-1)

To the rubber-like polymer solution (VS) before hydrogenation obtained as described above (Polymerization Example 4), the hydrogenation catalyst (NA-1) prepared as described above (Production Example 1) was added in an amount, in terms of Ni, of 70 ppm per 100 parts by mass of the rubber-like polymer before hydrogenation, followed by a hydrogenation reaction at a hydrogen pressure of 0.9 MPa and an average temperature of 85° C. for 120 minutes, and thus, a rubber-like polymer (V-1) was obtained. The rubber-like polymer thus obtained had an iodine value of 9.

To a solution of the thus obtained rubber-like polymer, 12.6 g of n-octadecyl-3-(3,5-di-t-butyl-4-hydroxyphenyl)-propionate and 3.0 g of 4,6-bis(octylthiomethyl)-o-cresol were added as antioxidants. Thereafter, 6,000 g of the resultant rubber composition solution was desolvated by the method described in <Desolvation Conditions 1>, and the resultant was dried with a dryer to obtain a rubber composition (VH-1).

Analysis results and evaluations of the rubber composition, and evaluations of a molded article are shown in Table 4.

TABLE 1

| | | Polymerization | Polymerization | Polymerization | Polymerization | Polymerization | Polymerization |
|---|---|---|---|---|---|---|---|
| | | Example 1 | Example 2 | Example 3 | Example 4 | Example 5 | Example 6 |
| Rubber-like Polymer (A) | | S | T | U | V | W | X |
| before Hydrogenation | | | | | | | |
| Weight Average Molecular | ten | 30 | 31 | 28 | 31 | 45 | 54 |
| Weight | thousand | | | | | | |
| Polymer Mooney Viscosity | | 47 | 37 | 58 | 32 | 59 | 52 |
| Modifier | | Compound 1 | Compound 2 | Compound 1 | Compound 1 | Compound 1 | Compound 1 |
| Amount of Bound Styrene | wt % | 10 | 26 | 26 | 0 | 10 | 10 |
| 1,2-Vinyl Bond Content | mol % | 37 | 55 | 40 | 40 | 37 | 37 |

Compounds 1 and 2 shown as modifiers in Table 1 are as follows:
Compound 1: 2,2-dimethoxy-1-(3-trimethoxysilylpropyl)-1-aza-2-silacyclopentane
Compound 2: N,N′-(1,4-phenylene)bis(4-triethoxysilyl)butan-1-imine)

TABLE 2

| | | Example | Example | Example | Example | Example | Example |
|---|---|---|---|---|---|---|---|
| | | 1 | 2 | 3 | 4 | 5 | 6 |
| Rubber-like Polymer (A) before Hydrogenation | | S | S | S | S | S | T |
| Rubber-like Polymer (A) | | S-1 | S-2 | S-3 | S-4 | S-5 | T-1 |
| Hydrogenation Catalyst | | NA-1 | NA-1 | NA-1 | NA-1 | NA-1 | NA-1 |
| Desolvation Conditions for Rubber Composition Solution | | 1 | 1 | 2 | 1 | 3 | 1 |
| Rubber Composition | | SH-1 | SH-2 | SH-3 | SH-4 | SH-5 | TH-1 |
| Oil | phr | 0 | 0 | 0 | 0 | 0 | 0 |
| Stearic Acid | phr | 0 | 0 | 0 | 0 | 0 | 0 |
| Amount of Bound Styrene in Rubber-like Polymer (A) | wt % | 10 | 10 | 10 | 10 | 10 | 26 |
| Amount of Styrene Block in Rubber-like Polymer (A) | mass % | 1.6 | 1.6 | 1.6 | 1.6 | 1.6 | 2.1 |
| Iodine Value of Rubber-like Polymer (A) | I g/100 g | 85 | 38 | 85 | 85 | 85 | 70 |
| Ethylene Structure in Rubber-like Polymer (A) | wt % | 49.6 | 51.2 | 49.6 | 49.6 | 49.6 | 30.7 |
| Conjugated Diene Monomer Unit in Rubber-like Polymer | mass % | 17.1 | 7.2 | 17.1 | 17.1 | 17.1 | 14.8 |
| (A) | | | | | | | |
| Modification Ratio of Rubber-like Polymer (A) | % | 50 | 50 | 50 | 50 | 50 | 50 |
| Al Content in Rubber Composition | ppm | 70 | 70 | 5 | 120 | 6 | 70 |
| Ni Content in Rubber Composition | ppm | 50 | 50 | 40 | 90 | 10 | 50 |
| Co Content in Rubber Composition | ppm | 0 | 0 | 0 | 0 | 0 | 0 |
| Ti Content in Rubber Composition | ppm | 0 | 0 | 0 | 0 | 0 | 0 |
| Water Content in Rubber Composition | mass % | 0.5 | 0.5 | 0.5 | 0.5 | 0.5 | 0.5 |

| | | | | | | |
|---|---|---|---|---|---|---|
| Molded Form | Bale | Bale | Bale | Bale | Bale | Bale |
| Cold Flow Property | ◯ | ⊚ | Δ | ⊚ | ◯ | ◯ |
| Thermal Deterioration (ΔT) | ◯ | ⊚ | ⊚ | Δ | ◯ | ◯ |

TABLE 3

| | | Example | Example | Example | Example | Example | Example |
|---|---|---|---|---|---|---|---|
| | | 7 | 8 | 9 | 10 | 11 | 12 |
| Rubber-like Polymer (A) before Hydrogenation | | S | S | S | T | W | X |
| Rubber-like Polymer (A) | | S-6 | S-7 | S-8 | T-2 | W-1 | X-1 |
| Hydrogenation Catalyst | | NA-1 | NA-1 | NA-1 | NA-1 | NA-1 | NA-1 |
| Desolvation Conditions for Rubber Composition Solution | | 1 | 1 | 1 | 1 | 1 | 1 |
| Rubber Composition | | SH-6 | SH-7 | SH-8 | TH-2 | WH-1 | XH-1 |
| Oil | phr | 5 | 0 | 0 | 0 | 0 | 0 |
| Stearic Acid | phr | 0 | 0.2 | 0 | 0 | 0 | 0 |
| Amount of Bound Styrene in Rubber-like Polymer (A) | wt % | 10 | 10 | 10 | 26 | 10 | 10 |
| Amount of Styrene Block in Rubber-like Polymer (A) | mass % | 1.6 | 1.6 | 1.6 | 2.1 | 1.5 | 1.6 |
| Iodine Value of Rubber-like Polymer (A) | I g/100 g | 38 | 85 | 85 | 129 | 85 | 85 |
| Ethylene Structure in Rubber-like Polymer (A) | wt % | 51.2 | 49.6 | 49.6 | 22.2 | 49.6 | 49.6 |
| Conjugated Diene Monomer Unit in Rubber-like Polymer | mass % | 7.2 | 17.1 | 17.1 | 27.4 | 17.1 | 17.1 |
| (A) | | | | | | | |
| Modification Ratio of Rubber-like Polymer (A) | % | 50 | 50 | 50 | 50 | 80 | 35 |
| Al Content in Rubber Composition | ppm | 65 | 70 | 70 | 70 | 70 | 70 |
| Ni Content in Rubber Composition | ppm | 48 | 50 | 50 | 50 | 50 | 50 |
| Co Content in Rubber Composition | ppm | 0 | 0 | 0 | 0 | 0 | 0 |
| Ti Content in Rubber Composition | ppm | 0 | 0 | 0 | 0 | 0 | 0 |
| Water Content in Rubber Composition | mass % | 0.5 | 0.5 | 1.7 | 0.5 | 0.5 | 0.5 |

| | | | | | | |
|---|---|---|---|---|---|---|
| Molded Form | Bale | Bale | Bale | Bale | Bale | Bale |
| Cold Flow Property | ⊚ | ◯ | ◯ | Δ | ⊚ | Δ |
| Thermal Deterioration (ΔT) | ⊚ | ◯ | ◯ | ◯ | ◯ | ◯ |

TABLE 4

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Rubber-like Polymer (A) before Hydrogenation | | S | S | S | T | U | V |
| Rubber-like Polymer (A) | | S-9 | S-10 | S-11 | T-3 | U-1 | V-1 |
| Hydrogenation Catalyst | | TC-1 | NA-1 | NA-1 + TC-1 | NA-1 | NA-1 | NA-1 |
| Desolvation Conditions for Rubber | | 1 | 1 | 3 | 1 | 1 | 1 |
| Composition Solution | | | | | | | |
| Rubber Composition | | SH-9 | SH-10 | SH-11 | TH-3 | UH-1 | VH-1 |
| Oil | phr | 0 | 0 | 0 | 0 | 0 | 0 |
| Stearic Acid | phr | 0 | 0 | 0 | 0 | 0 | 0 |
| Amount of Bound Styrene in | wt % | 10 | 10 | 10 | 26 | 26 | 0 |
| Rubber-like Polymer (A) | | | | | | | |
| Amount of Styrene Block in | mass % | 1.6 | 1.6 | 1.6 | 2.1 | 15 | 0 |
| Rubber-like Polymer (A) | | | | | | | |
| Iodine Value of Rubber-like | I g/100 g | 85 | 85 | 85 | 209 | 70 | 9 |
| Polymer (A) | | | | | | | |
| Ethylene Structure in Rubber-like | wt % | 40.4 | 48.7 | 42.0 | 1.1 | 38.5 | 58.2 |
| Polymer (A) | | | | | | | |
| Conjugated Diene Monomer Unit in | mass % | 18 | 18 | 18 | 44.4 | 14.8 | 2 |
| Rubber-like Polymer (A) | | | | | | | |
| Modification Ratio of Rubber-like | % | 50 | 50 | 50 | 50 | 50 | 50 |
| Polymer (A) | | | | | | | |
| Al Content in Rubber Composition | ppm | 0 | 220 | 2 | 70 | 70 | 70 |
| Ni Content in Rubber Composition | ppm | 0 | 160 | 1 | 50 | 50 | 50 |
| Co Content in Rubber Composition | ppm | 0 | 0 | 0 | 0 | 0 | 0 |
| Ti Content in Rubber Composition | ppm | 50 | 0 | 20 | 0 | 0 | 0 |
| Water Content in Rubber Composition | mass % | 0.5 | 0.5 | 0.5 | 0.5 | 0.5 | 0.5 |

| | | | | | | |
|---|---|---|---|---|---|---|
| Molded Form | Bale | Bale | Bale | Bale | Bale | Bale |
| Cold Flow Property | x | ⊚ | x | x | ◯ | Δ |
| Thermal Deterioration (ΔT) | ◯ | x | ◯ | x | ◯ | Δ |

### [Examples 13 to 24] and [Comparative Examples 7 to 12]

[Preparation of Rubber Composition for Crosslinking and Evaluation of Physical Properties]

Examples 1 to 12 and Comparative Examples 1 to 6 (rubber compositions: SH-1 to SH-11, TH-1 to TH-3, UH-1, VH-1, WH-1, and XH-1) shown in Tables 2 to 4 were used as raw material rubber components to obtain rubber composition for crosslinkings containing respective raw material rubbers in accordance with the following compositions.

(Rubber Components)
Rubber composition (each of samples SH-1 to SH-11, TH-1 to TH-3, UH-1, VH-1, WH-1, and XH-1): 80 parts by mass (parts by mass excluding a rubber softener)
High cis polybutadiene (trade name “UBEPOL BR150”, manufactured by Ube Industries, Ltd.): 20 parts by mass

(Blending Conditions)

The amount of each compounding agent added was expressed in parts by mass with respect to 100 parts by mass of the rubber component excluding a rubber softener.
Silica 1 (trade name “Ultrasil 7000GR” manufactured by Evonik Degussa, nitrogen adsorption specific surface area: 170 m²/g): 50.0 parts by mass
Silica 2 (trade name “Zeosil Premium 200 MP” manufactured by Rhodia, nitrogen adsorption specific surface area: 220 m²/g): 25.0 parts by mass
Carbon black (trade name “Seast KH (N339)” manufactured by Tokai Carbon Co., Ltd.): 5.0 parts by mass
Silane coupling agent (trade name “Si75” manufactured by Evonik Degussa, bis(triethoxysilylpropyl)disulfide): 6.0 parts by mass
SRAE oil (trade name “Process NC140” manufactured by JX Nippon Oil & Energy Corporation): 25.0 parts by mass
Zinc powder: 2.5 parts by mass
Stearic acid: 1.0 part by mass
Anti-aging agent (N-(1,3-dimethylbutyl)-N′-phenyl-p-phenylenediamine): 2.0 parts by mass
Sulfur: 2.2 parts by mass
Vulcanization accelerator 1 (N-cyclohexyl-2-benzothiazylsulfinamide): 1.7 parts by mass
Vulcanization accelerator 2 (diphenylguanidine): 2.0 parts by mass
Total: 222.4 parts by mass

(Kneading Method)

The above-described materials were kneaded as follows to obtain a rubber composition.

A closed kneader (having an internal capacity of 0.3 L) equipped with a temperature controller was used to knead, as first stage kneading, the raw material rubber (any one of the samples SH-1 to SH-11, TH-1 to TH-3, UH-1, VH-1, WH-1, and XH-1), the fillers (silica 1, silica 2, and carbon black), the silane coupling agent, the SRAE oil, zinc powder and stearic acid under conditions of a filling rate of 65% and a rotor speed of 30 to 50 rpm. Here, the temperature of the closed mixer was controlled to obtain the rubber composition (compound) at a discharge temperature of 155 to 160° C.

Next, as second stage kneading, after the compound obtained as described above was cooled to room temperature, the anti-aging agent was added thereto, and the resultant was kneaded again for improving dispersibility of the silica. Also in this case, the discharge temperature of the compound was adjusted to 155 to 160° C. by the temperature control of the mixer.

After cooling, as third stage kneading, the resultant was kneaded with sulfur and the vulcanization accelerators 1 and 2 added thereto with an open roll set to 70° C. Thereafter, the resultant was molded, and vulcanized with a vulcanization press at 160° C. for 20 minutes. The rubber composition before vulcanization and the rubber composition after the vulcanization were evaluated. Specifically, the evaluations were performed by the following methods.

Results are shown in Tables 5 to 7.

(Evaluations 1 and 2) Rigidity at 50° C. (Viscosity Parameter)

A viscosity tester “ARES” manufactured by Rheometric Scientific was used to measure a viscosity parameter in a twist mode.

A storage modulus (G′) measured at 50° C., a frequency of 10 Hz, and a strain of 3% was used as an index of steering stability. A larger index indicates better steering stability.

Tables 5 to 7 show, with the physical property of the compound of Comparative Example 7 used as a reference, signs corresponding to changes of the storage modulus in the following ranges.

Δ: from deterioration by less than 5% to improvement by less than 5%

◯: from improvement by 5% or more to improvement by less than 15%

⊚: from improvement by 15% or more to improvement by less than 20%

X: deterioration by 5% or more

A tan δ measured at 50° C., a frequency of 10 Hz, and a strain of 3% was used as an index of fuel economy. A smaller index indicates better fuel economy.

Tables 5 to 7 show, with the physical property of the compound of Comparative Example 7 used as a reference, signs corresponding to changes of the fuel economy in the following ranges.

Δ: from deterioration by less than 5% to improvement by less than 5%

◯: from improvement by 5% or more to improvement by less than 15%

⊚: from improvement by 15% or more to improvement by less than 20%

X: deterioration by 5% or more

(Evaluations 3 and 4) Fracture Property, and Change of Tensile Strength after Thermal History

Breaking strength and elongation at break were measured in accordance with a tensile test method of JIS K6251. A product of measured values of the breaking strength and the elongation at break was defined as a fracture property.

Tables 5 to 7 show, with the physical property of the compound of Comparative Example 7 used as a reference, signs corresponding to changes of the fracture property in the following ranges.

Δ: from deterioration by less than 5% to improvement by less than 5%

◯: from improvement by 5% or more to improvement by less than 15%

⊚: from improvement by 15% or more to improvement by less than 20%

X: deterioration by 5% or more

Besides, after heating each compound at 120° C. for 5 hours, the breaking strength was measured in the same manner as described above to calculate a change of the breaking strength caused by heating. It was assumed that as the change is smaller, heat resistance is good and hence the production is sustained, and change of tensile strength after thermal history was evaluated as good.

In Tables 5 to 7, the change of tensile strength after thermal history was evaluated as ⊚ when the change of the breaking strength caused by heating was 0 MPa or more and less than 1.0 MPa, as ◯ when it was 1.0 MPa or more and less than 2.5 MPa, as Δ when it was 2.5 MPa or more and less than 4.0 MPa, and as X when it was 4.0 MPa or more.

TABLE 5

| | Example | Example | Example | Example | Example | Example |
|---|---|---|---|---|---|---|
| Example | 13 | 14 | 15 | 16 | 17 | 18 |
| Compound Example | Compound | Compound | Compound | Compound | Compound | Compound |
| | Example 1 | Example 2 | Example 3 | Example 4 | Example 5 | Example 6 |
| Rubber Composition | SH-1 | SH-2 | SH-3 | SH-4 | SH-5 | TH-1 |
| Storage Modulus | ◯ | ⊚ | ◯ | ◯ | Δ | ⊚ |
| Fuel Economy | Δ | Δ | Δ | Δ | Δ | Δ |
| Fracture Property | Δ | ⊚ | Δ | Δ | Δ | ◯ |
| Change of Tensile Strength | Δ | ◯ | Δ | Δ | ◯ | Δ |
| after Thermal History | | | | | | |

TABLE 6

| | Example | Example | Example | Example | Example | Example |
|---|---|---|---|---|---|---|
| Example | 19 | 20 | 21 | 22 | 23 | 24 |
| Compound Example | Compound | Compound | Compound | Compound | Compound | Compound |
| | Example 7 | Example 8 | Example 9 | Example 10 | Example 11 | Example 12 |
| Rubber Composition | SH-6 | SH-7 | SH-8 | TH-2 | WH-1 | XH-1 |
| Storage Modulus | ⊚ | ◯ | ◯ | ◯ | ◯ | ◯ |
| Fuel Economy | Δ | Δ | Δ | Δ | ⊚ | Δ |
| Fracture Property | ⊚ | Δ | Δ | ◯ | ◯ | ◯ |
| Change of Tensile Strength | ◯ | Δ | Δ | Δ | Δ | Δ |
| after Thermal History | | | | | | |

TABLE 7

| | Comparative | Comparative | Comparative | Comparative | Comparative | Comparative |
|---|---|---|---|---|---|---|
| Example | Example 7 | Example 8 | Example 9 | Example 10 | Example 11 | Example 12 |
| Compound Example | Compound | Compound | Compound | Compound | Compound | Compound |
| | Example 13 | Example 14 | Example 15 | Example 16 | Example 17 | Example 18 |
| Rubber Composition | SH-9 | SH-10 | SH-11 | TH-3 | UH-1 | VH-1 |
| Storage Modulus | Δ | ◯ | Δ | Δ | ◯ | x |
| Fuel Economy | Δ | Δ | Δ | Δ | x | Δ |
| Fracture Property | Δ | ◯ | Δ | x | ◯ | x |
| Change of Tensile Strength | ◯ | x | ◯ | x | Δ | ◯ |
| after Thermal History | | | | | | |

As shown in Tables 2 to 4, it was confirmed that Examples 1 to 12 are excellent in the cold flow property and the thermal deterioration of the molded articles of the rubber compositions as compared with Comparative Examples 1 to 6.

In addition, as shown in Tables 5 to 7, it was confirmed that the compounds using the rubber compositions of Examples 1 to 12 are equivalent to or better than the compounds using the rubber compositions of Comparative Examples 1 to 6 in the physical property balance.

The rubber composition of the present invention is suitable as a constituent material of a rubber composition for crosslinking, and specifically, is industrially applicable in the fields of tire members, interiors and exteriors of vehicles, anti-vibration rubbers, belts, shoes, foam materials, various industrial products, and the like.

1. A molded bale of a rubber composition comprising:
a rubber-like polymer (A) having an iodine value of 10 to 250, 3% by mass or more of an ethylene structure, and less than 10% by mass of a vinyl aromatic monomer block;
aluminum (B); and
nickel and/or cobalt (C),
wherein a content of the aluminum (B) is 2 ppm or more and 200 ppm or less, and
a content of the nickel and/or cobalt (C) is 3 ppm or more and 100 ppm or less.

2. The molded bale according to claim 1, wherein the rubber-like polymer (A) is a hydrogenated product of a conjugated diene-based polymer.

3. The molded bale according to claim 1, wherein the rubber-like polymer (A) comprises 5% by mass or more of a vinyl aromatic monomer unit.

4. The molded bale according to claim 1, wherein the rubber-like polymer (A) comprises a nitrogen atom.

5. The molded bale according to claim 1, wherein the rubber-like polymer (A) has a modification ratio measured by column adsorption GPC of 40% by mass or more.

6. The molded bale according to claim 1, further comprising 30% by mass or less of a rubber softener (D).

7. The molded bale according to claim 1, comprising a water content of 0.05% by mass or more and 1.5% by mass or less.

8. A method for producing the molded bale according to claim 1, comprising:
a step of polymerizing the rubber-like polymer (A) in a solution;
a step of adding the aluminum (B) and the nickel and/or cobalt (C) to the solution containing the rubber-like polymer (A) to obtain a rubber composition; and
a step of molding the rubber composition containing the rubber-like polymer (A), the aluminum (B), and the nickel and/or cobalt (C).

9. The method for producing the molded bale according to claim 8, comprising:
a step of removing a solvent by steam stripping from the solution containing the rubber-like polymer (A).

10. The method for producing the molded bale according to claim 8, wherein the nickel and/or cobalt is allowed to remain in the rubber composition in such a manner that a content of the nickel and/or cobalt in the rubber composition is 10% by mass or more based on an amount of the nickel and/or cobalt added to the solution containing the rubber-like polymer (A).

11. A rubber composition for crosslinking, comprising:
the rubber composition of the molded bale according to claim 1; and
a crosslinking agent,
wherein the crosslinking agent is contained in an amount of 0.1 parts by mass or more and 20 parts by mass or less with respect to 100 parts by mass of a rubber component.

12. A tread for a tire, comprising the rubber composition of the molded bale according to claim 1.
